(19) United States
(12) Patent Application Publication
(10) Pub. No.: US 2009/0260005 A1
(43) Pub. Date: Oct. 15, 2009

(54) SYSTEM AND METHOD FOR PROVIDING SERVICE

(75) Inventors: Ikuo Nakagawa, Tokyo (JP); Hidemi Hirai, Tokyo (JP)

Correspondence Address: FOLEY AND LARDNER LLP;SUITE 500, 3000 K STREET NW, WASHINGTON, DC, 20007, US

(73) Assignee: Intec NetCore, Inc.

(21) Appl. No.: 12/419,487

(22) Filed: Apr. 7, 2009

(30) Foreign Application Priority Data
Apr. 9, 2008 (JP) 2008-101273

(51) Int. Cl. G06F 9/445; G06F 15/173

(52) U.S. Cl. 717/177; 709/226; 709/223

(57) ABSTRACT

A system includes user accommodation apparatuses at various locations and a central apparatus. A user accommodation apparatus concerned accepts a use request from a user of a terminal, and determines which one of the user accommodation apparatuses the user is currently associated with, based on first information managed by the central apparatus. The user accommodation apparatus concerned uses the determined one of the user accommodation apparatuses, to obtain second information for specifying where in the system the user's copy of an application program is held, and causes the user's copy of an application program designated by the user to move from one of the user accommodation apparatuses specified by the second information to the user accommodation apparatus concerned. Thus, the user's copy of the designated application program in the user accommodation apparatus concerned operates to communicate with the terminal, thereby providing a service to the user.

### BACKGROUND OF THE INVENTION

1. Field of the Invention

The present invention relates to a technique, in a service provision system comprising a central apparatus (server) and user accommodation apparatuses (servers) located at various locations, for allowing a user moving between the locations to receive a service provided by the system, from a terminal connected to a user accommodation apparatus at a location to which the user has moved.

2. Background

Recently, “virtualization” technology for servers and storages has attracted attention as a technology that reduces the operation and management cost of a distributed information processing system and allows resources to be used flexibly. Additionally, in a method where a copy of an application program is installed in a terminal of each user, it is required to manage as many OSs and application programs as the number of terminals; it is difficult to make environments of all the terminals identical to the latest; and there is a fear of information leakage since data is managed by users, so recently there are expectations for virtualization of applications (e.g. see “Citrix Presentation Server Unyou Kanri Guide” (Citrix Presentation Server Operation and Management Guide), Softbank Creative, published on Nov. 30, 2005).

Virtualization of applications includes a method, such as “Citrix Presentation Server” of Citrix Systems, Inc., in which all application programs are operated in a server (data center) and only screen images and keyboard/mouse signals are encrypted to be transmitted to and received from user terminals. In this method, programs and data can be centrally managed by the system since application programs are executed on the server; and the latest environment can be flexibly introduced since there is no dependence on OSs and devices of user terminals. Moreover, the method is secure because: resource access control can be set differently depending on who the user is; signals transmitted and received over the network are not actual data; and data is not left in terminals.

There have previously been many “ASPs” (Application Service Providers), which are operators that provide users with functions of applications as services via networks, and a user would only have to prepare on the terminal, for example, a Web browser that can execute a Java program to be able to access a server on the ASP side to receive an application service. In this method also, since application programs are executed and centrally managed by the ASP side, upgrades, specification changes, and the like of applications can be easily done (e.g. see “ASP (Application Service Provider) no Subete ga Wakaru Hon (Zukai Web Computing)” (All about ASP—Illustrated Web Computing), JMA Management Center, Published on October, 2000).

In the above-described application service technique, an application program to be used always exists in a fixed place, i.e. a server of a service providing origin (data center), and therefore a user can receive a service with an identical application program and stored data via a network, whenever and wherever the user moves, from a terminal there (which may be a different terminal from a terminal before the move).

In the above-described application service technique, however, a user has to access data centers different from each other for each service via a network in order to use a desired service. When a user uses a certain service, the user has to access only one identical data center no matter from where the user connects to the network. Therefore, when the user connects to the network at a location distant from the data center, the influence of delay becomes greater. As a result, the user could not substantially receive the service if the service is for an application that strictly requires real-time processing between the server and the client (e.g. an interactive application or an application whose circumstances change significantly with time, such as an online fighting game, a real-time questionnaire, etc.).

In other words, the above technique separates an environment where an application is executed (server) and an environment where a service is used (user terminal), and therefore causes inconvenience when the distance between the server and the user terminal is large, though having the convenience of being able to use the identical service even when the user is in a move destination.

There is a CDN (Content Delivery Network) as a technique for efficiently delivering contents by mirroring them across multiple servers distributed geographically or on a backbone basis in order to avoid access concentration on one server of a provider. With the technique, however, only a copy of mere contents, not an application, can be placed near a location where a user uses it, and such placing can be effective only in a case of delivering mere data such as video streams.

### SUMMARY OF THE INVENTION

Methods and systems consistent with the invention can provide an application service in a service provision system with distributed servers, wherein a user may be allowed to use an identical service provided by the system, delay occurring between a user terminal and a running application may be reduced, and various kinds of service may be provided without trouble, whichever location the user moves to and even if the terminal to be connected there is different from the terminal used before the move.

From another aspect, methods and systems consistent with the invention can realize a mechanism in which an environment where an application is executed is prepared for each individual user and moves to a location of the user's move destination.

A system consistent with the invention may include a plurality of user accommodation apparatuses each having a unit for connecting with a terminal of a user and a central apparatus having a unit for communicating with each of the plurality of user accommodation apparatuses.

A user accommodation apparatus concerned in one example consistent with the invention may comprise: a unit that accepts a use request from a user of a terminal connected; a unit that determines which one of the plurality of user accommodation apparatuses the user whose use request is accepted is currently associated with, based on first information managed by the central apparatus; a unit that uses the determined one of the plurality of user accommodation apparatuses, to obtain second information for specifying where in the system the user's copy of an application program is held; a unit that causes the user's copy of an application program designated by the user to move from one of the plurality of user accommodation apparatuses specified by the second information to the user accommodation apparatus concerned; and a unit that causes the user's copy of the designated application program in the user accommodation apparatus concerned to operate to communicate with the terminal, thereby providing a service to the user, the user's copy of the application program being held in the system after the communication with the terminal is finished.

In another example consistent with the invention, a central apparatus may manage first information indicating which one of a plurality of user accommodation apparatuses the user is currently associated with, and one of the plurality of user accommodation apparatuses, which the user is currently associated with, may hold second information for specifying where in the system the user's copy of each application program is held. In this case, each of the plurality of user accommodation apparatuses may comprise: a unit that accepts a use request from a user of a terminal connected; a unit that determines which one of the plurality of user accommodation apparatuses the user whose use request is accepted is currently associated with, based on the first information; a unit that acquires the second information from the determined one of the plurality of user accommodation apparatuses; a unit that causes the user's copy of an application program designated by the user to move from one of the plurality of user accommodation apparatuses specified by the second information to the user accommodation apparatus concerned; and a unit that causes the user's copy of the designated application program in the user accommodation apparatus concerned to operate to communicate with the terminal.

In yet another example consistent with the invention, a central apparatus may manage first information indicating which one of a plurality of user accommodation apparatuses the user is currently associated with, and one of the plurality of user accommodation apparatuses, which the user is currently associated with, may hold a portal program for the user. In this case, each of the plurality of user accommodation apparatuses may comprise: a unit that accepts a use request from a user of a terminal connected; a unit that determines which one of the plurality of user accommodation apparatuses the user whose use request is accepted is currently associated with, based on the first information; a unit that causes the portal program for the user to move from the determined one of the plurality of user accommodation apparatuses to the user accommodation apparatus concerned; a unit that causes the portal program for the user in the user accommodation apparatus concerned to operate, causing second information for specifying where in the system the user's copy of an application program designated by the user is held to be referred to, and causing the user's copy of the designated application program to move from one of the plurality of user accommodation apparatuses specified by the second information to the user accommodation apparatus concerned; and a unit that causes the user's copy of the designated application program in the user accommodation apparatus concerned to operate to communicate with the terminal.

A method of providing a service to a user in a system consistent with the invention may comprise: configuring the system to hold the user's copy of an application program; locating in the central apparatus first information indicating which one of the plurality of user accommodation apparatuses the user is currently associated with; causing a user accommodation apparatus among the plurality of user accommodation apparatuses that has accepted a use request from a user of a terminal to determine which one of the plurality of user accommodation apparatuses the user is currently associated with based on the first information, and to use the determined one of the plurality of user accommodation apparatuses to obtain second information for specifying where in the system the user's copy of an application program is held; moving the user's copy of an application program designated by the user from one of the plurality of user accommodation apparatuses specified by the second information to the user accommodation apparatus that has accepted the use request; and causing the user accommodation apparatus that has accepted the use request to operate the moved user's copy of the application program to communicate with the terminal.

A computer usable medium having computer readable program codes embodied therein to be incorporated into a computer system, whereby the computer system functions as a system consistent with the invention, may comprise: program codes for configuring the system to hold the user's copy of an application program; program codes for locating in the central apparatus first information indicating which one of the plurality of user accommodation apparatuses the user is currently associated with; program codes for causing a user accommodation apparatus among the plurality of user accommodation apparatuses that has accepted a use request from a user of a terminal to determine which one of the user accommodation apparatuses the user is currently associated with based on the first information, and to use the determined one of the plurality of user accommodation apparatuses to obtain second information for specifying where in the system the user's copy of an application program is held; program codes for moving the user's copy of an application program designated by the user from one of the plurality of user accommodation apparatuses specified by the second information to the user accommodation apparatus that has accepted the use request; and program codes for causing the user accommodation apparatus that has accepted the use request to operate the moved user's copy of the application program to communicate with the terminal.

As described hereafter, other aspects of the invention exist. Thus, this summary of the invention is intended to provide a few aspects of the invention and is not intended to limit the scope of the invention described and claimed herein.

### BRIEF DESCRIPTION OF THE DRAWINGS

The accompanying drawings are incorporated in and constitute a part of this specification. The drawings exemplify certain aspects of the invention and, together with the description, serve to explain examples consistent with some principles of the invention.

FIG. 1 shows an example of the configuration of a service provision system and user terminals in an embodiment consistent with the invention;

FIG. 2 shows an example of the configuration of a central server in an embodiment consistent with the invention;

FIG. 3 shows an example of the configuration of a user accommodation server at each location in an embodiment consistent with the invention;

FIG. 4 illustrates an example of a user's own application's copy and its “move” in the system;

FIG. 5 illustrates an example of a user's own portal's “move” and its role in the system;

FIG. 6 is a flowchart showing an example of an operation of a user accommodation server that has accepted a use request from a user;

FIG. 7 is a flowchart showing an example of an operation of a user accommodation server that has accepted a designation of an application from a user via the user's own portal;

FIG. 8 illustrates an example of the statuses of the center and each location at a time when a user has issued a use request at a location of a move destination;

FIG. 9 illustrates an example of the statuses of the center and each location at a time when the user' own portal has moved in; and

FIG. 10 illustrates an example of the statuses of the center and each location at a time when the user's own copy of the designated application has moved in.

### DETAILED DESCRIPTION

The following detailed description refers to the accompanying drawings. Although the description includes exemplary implementations, other implementations are possible and changes may be made to the implementations described without departing from the spirit and scope of the invention. The following detailed description and the accompanying drawings do not limit the invention. Instead, the scope of the invention is defined by the appended claims.

### General Description

In a case of delivering an application program, the environment itself where the application is executed is desired to “move” near a location where a user uses it, in order to solve the delay problem. The environment where the application is executed includes the “status” of the application that depends on how each individual user uses it.

In the conventional technique, however, such status information for each user is held only while a user is accessing an application server to use a service, and the status cannot be restored except for one stored particularly as data when the user temporarily stops the use and accesses again. Even in a case where a web page for each user is prepared as a portal in an ASP, the status for each user (e.g. a taskbar, a short cut, how to use work space, an application such as a simulation reflecting the “status” being processed on the way, or the like) is not restored and prepared there.

Therefore, some methods and systems consistent with the invention may aim to “move” an environment where an application is executed, including such status of each user, near a location where a user uses a service.

An example of a service provision system consistent with the invention comprises: a plurality of user accommodation apparatuses each having a unit for connecting with a terminal of a user; and a central apparatus having a unit for communicating with each of the plurality of user accommodation apparatuses, where the service provision system causes the user's copy of an application program in one of the plurality of user accommodation apparatuses to operate to communicate with the terminal of the user, thereby providing a service to the user, and holds the user's copy of the application program after the communication with the terminal of the user is finished.

An example of a user accommodation apparatus concerned consistent with the invention in the above service provision system may comprise: a unit that accepts a use request from a user of a terminal connected; a unit that determines which one of the plurality of user accommodation apparatuses the user whose use request is accepted is currently associated with, based on first information managed by the central apparatus; a unit that uses the determined one of the plurality of user accommodation apparatuses, to obtain second information for specifying where in the system the user's copy of an application program is held; a unit that causes the user's copy of an application program designated by the user to move from one of the plurality of user accommodation apparatuses specified by the second information to the user accommodation apparatus concerned; and a unit that causes the user's copy of the designated application program in the user accommodation apparatus concerned to operate to communicate with the terminal.

In this configuration, if a user is provided with a service, by the user's own copy of an application program designated by the user, via a terminal connected to a user accommodation apparatus at a certain location; moves afterward to another location; and designates the same application program as before the move via a terminal connected to a user accommodation apparatus there (which may be a terminal different from the one used before the move), then the user is provided with the continued service by the user's own copy which is the same as before the move. That is, the user can receive the usual service no matter if the user moves to another location or if the terminal changes. Moreover, since the user's own copy of the designated application program then moves from the user accommodation apparatus at the location before the move to the user accommodation apparatus at the current location (of the move destination), the user terminal can communicate with the running application program with little delay.

The above user accommodation apparatus may further comprise: a unit that holds the user's copy of the designated application program in the user accommodation apparatus concerned, after the communication with the terminal is finished; a unit that rewrites the second information such that the second information specifies that the user's copy of the designated application program is held in the user accommodation apparatus concerned; and a unit that moves, upon a request from another user accommodation apparatus, the user's copy of the designated application program from the user accommodation apparatus concerned to said another user accommodation apparatus.

Consequently, instead of the user's own copies of all application programs moving together between user accommodation apparatuses each time the user moves between locations, the user's own copy can be made to stay at the last location where the service using the application concerned was provided to the user, and not to move, until when the identical application is designated afterward, to the location where the user exists at that time. That is, since the user's own copy of an application program is not required to be near the user while the application is not used or while the communication with the user terminal is not performed, the copy is not moved to another location, even if the user is using another application there, until the copy is required. As a result, network resources are not wasted to move the user's own copy that is unused, and resources can be effectively utilized.

The above user accommodation apparatus may further comprise a unit that moves the user's copy of the designated application program held in the user accommodation apparatus concerned to the central apparatus when there are no requests from other user accommodation apparatuses for a prescribed time period or when there occurs any trouble in holding in the user accommodation apparatus concerned.

This allows the user's own copy, which stays in a user accommodation apparatus at a location where it was last used without moving to another location because of the user not using the application concerned, to be made to stop uselessly occupying resources of the user accommodation apparatus and to be collected by the central apparatus.

In this regard, in an example consistent with the invention, a copy of one application and a copy of another application are expected to be held in a distributed manner at one location and another location, respectively, even if the copies are for an identical user. The second information covers, for each user, which user accommodation apparatus at which location the user's own copy of each application is held in.

In one embodiment consistent with the invention, the above second information is made to exist in one of the plurality of user accommodation apparatuses. In this case, the second information for one user and the second information for another user can exist in a distributed manner at one location and another location, respectively. Then, a user accommodation apparatus that uses the second information in order to move a user's own copy of the user's desired application to the apparatus concerned may first examine which location the second information for the user exists at. Which user accommodation apparatus the second information for each user exists in is determined depending on which user accommodation apparatus each user is currently associated with, and can be indicated by the first information managed by the central apparatus.

The above configuration allows each user accommodation apparatus to autonomously trace information distributed across a plurality of locations to bring over the user's own copy of a required application, instead of the central apparatus centrally controlling the user's own copy of the application to move between locations.

In another embodiment consistent with the invention, the above second information is made to exist in the central apparatus. In this case also, the user accommodation apparatus with which the user is currently associated, among the plurality of user accommodation apparatuses, can be used in obtaining the above second information. For example, a portal program for each user is made to exist in one of the plurality of user accommodation apparatuses, and a user accommodation apparatus that is to bring over a user's own copy of the user's desired application causes a portal program for the user to move in advance from the user accommodation apparatus with which the user is currently associated to the user accommodation apparatus concerned. Then, the user accommodation apparatus concerned communicates with the central apparatus via the moved portal program, and thereby obtains the second information. Which user accommodation apparatus a portal program for each user exists in can be indicated by the first information managed by the central apparatus.

While in this configuration the central apparatus manages not only the first information but also the second information, each user accommodation apparatus can still autonomously trace information distributed across a plurality of locations to bring over the user's own copy of a required application.

A user accommodation apparatus concerned in the example consistent with the invention may further comprise a unit that stores information indicating which user is currently associated with the user accommodation apparatus concerned. In this case, when the stored information indicates that the user whose use request is accepted is currently associated with the user accommodation apparatus concerned, the determination based on the first information is performed by determining the user accommodation apparatus concerned to be the one with which the user is currently associated, and when the stored information indicates that the user is not associated, the determination based on the first information is performed by communicating with the central apparatus to cause the first information to be referred to, thereby searching for the user accommodation apparatus with which the user is currently associated.

Consequently, a user accommodation apparatus concerned, which is to move a user's own copy of the user's desired application to the apparatus concerned, can determine which user accommodation apparatus the user is currently associated with out inquiring of the central apparatus, when the second information and/or portal program for the user exists in the apparatus concerned itself. Thus, autonomy of each user accommodation apparatus can be further enhanced as to information managed by the central apparatus.

A user accommodation apparatus concerned in the example consistent with the invention may further comprise: a unit that enables the user's copy of the designated application program to be newly created when the second information indicates that the user's copy of the designated application program does not exist in the system; and a unit that makes an addition to the second information such that the second information specifies that, as to the application program whose copy for the user is newly created, the user's copy is held in the user accommodation apparatus concerned.

This may allow the user's own only one copy of the application to exist in the service provision system and to move to the location where the user exists. Consequently, a situation where an identical user's own copies of an identical application exist here and there in the system with their statuses being slightly different from one another can be avoided, and the resources of the whole system can be effectively utilized while ease of use is improved.

An example consistent with another aspect of the invention is configured such that no matter if a user moved to another location or if a terminal changes, a usual “portal” is invoked, from which the user can enter the operation for receiving services that use respective applications.

For example, the user accommodation apparatus with which the user is currently associated may hold a portal program for the user and the second information, and obtainment of the second information by a user accommodation apparatus concerned in one embodiment consistent with the invention may include: causing the portal program for the user and the second information to move from the determined one of the plurality of user accommodation apparatuses to the user accommodation apparatus concerned; causing the portal program for the user in the user accommodation apparatus concerned to operate; causing the user to designate a desired application program through communication between the portal program and the terminal; and causing the second information in the user accommodation apparatus concerned to be referred to for the designated application program.

This may allow the user's portal program to move between user accommodation apparatuses in such a manner as chasing after the user moving from one location to another location, and also allow the second information indicating which location a copy of each application is held at to move with the user's portal program. The user is allowed to run, so to speak, the user's own virtual desktop at each location of his/her move destination, and to bring over the user's own copy of a required application and operate it, on the virtual desktop. The above virtual desktop includes the environment prepared for the user, and information indicating which location the user's own copy of each application exists at.

As another example, the user accommodation apparatus with which the user is currently associated may hold a portal program for the user, and the central apparatus may manage the second information. In this case, obtainment of the second information by a user accommodation apparatus concerned in another embodiment consistent with the invention may include: causing the portal program for the user to move from the determined one of the plurality of user accommodation apparatuses to the user accommodation apparatus concerned; causing the portal program for the user in the user accommodation apparatus concerned to operate; causing the user to designate a desired application program through communication between the portal program and the terminal; and causing the second information to be referred to for the designated application program through communication between the portal program and the central apparatus.

This may also allow the user's portal program to move between user accommodation apparatuses in such a manner as chasing after the user moving from one location to another location, and allow the user to use the user's own virtual desktop at each location of his/her move destination to bring over the user's own copy of a required application and operate it.

A user accommodation apparatus in the example consistent with another aspect of the invention may comprise: a unit that causes a portal program for the user to move to the user accommodation apparatus concerned; a unit that causes the portal program for the user in the user accommodation apparatus concerned to operate to communicate with the terminal; a unit that holds the portal program for the user in the user accommodation apparatus concerned, after the communication with the terminal is finished; a unit that causes the central apparatus to rewrite the first information such that the user accommodation apparatus concerned is determined to be the one with which the user is currently associated; and a unit that moves, upon a request from another user accommodation apparatus, the portal program for the user from the user accommodation apparatus concerned to said another user accommodation apparatus.

This may allow each user accommodation apparatus to autonomously bring over a portal for the user that exists at a certain location, instead of the central apparatus centrally controlling the portal for the user to move between locations, and also allow each user accommodation apparatus to autonomously cause the central apparatus to rewrite the first information managed by the central apparatus.

The above user accommodation apparatus may further comprise: a unit that enables a portal program for the user whose use request is accepted to be newly created when the first information indicates that the portal program for the user does not exist in the system; and a unit that causes, in response to the new creation of the portal program for the user, the central apparatus to generate the first information such that the user accommodation apparatus concerned is determined to be the one with which the user is currently associated.

This may allow only one portal program for the user to exist in the service provision system and to move to the location where the user exists. Consequently, a situation where portals for an identical user exist here and there in the system with their statuses being slightly different from one another can be avoided, and the resources of the whole system can be effectively utilized while ease of use is improved.

The above second information may be accompanied by third information indicating resources to be reserved for operation of the user's copy of an application program, and the user accommodation apparatus concerned may reserve the resources determined based on the third information, in advance of the movement of the user's copy of the application program. In an embodiment where the second information exists in one of the plurality of user accommodation apparatuses, the above third information may be held in the same user accommodation apparatus. In an embodiment where the second information exists in the central apparatus, the third information may be held in the central apparatus.

In an embodiment where the above second information exists in one of the plurality of user accommodation apparatus, the above third information may be separated from the second information to be managed by the central apparatus. In that case, obtainment of the second information by a user accommodation apparatus concerned in the example consistent with the invention may include causing the second information to move from the determined one of the plurality of user accommodation apparatuses to the user accommodation apparatus concerned, and the user accommodation apparatus concerned may reserve the resources determined by obtaining the third information through communication with the central apparatus, in advance of the movement of the user's copy of the application program.

With the use of the above third information, a user accommodation apparatus that is to bring over the user's own copy of an application to the apparatus concerned can reserve in advance resources required for the user's own application copy to operate in the apparatus concerned, and can immediately operate the brought-over application copy. Since the required resources may differ from copy to copy even if the application is the same and may change with time during operation, resources required for a copy made for each user are desirably determined based on the operating conditions immediately before the bringing over to be registered as the third information.

A user accommodation apparatus in the example consistent with the invention may further comprise: a unit that newly creates a general-purpose copy of an application program designated by the user; a unit that causes the general-purpose copy of the application program to operate to communicate with the terminal; and a unit that causes the general-purpose copy of the application program to disappear, after the communication with the terminal is finished.

Consequently, as to an application that does not require to hold the user's own copy after the use of the application to be able to recover the individual status of the user at a next use, a general-purpose copy can be made to be used at the location concerned without the user's own copy being brought over specially from another location.

An example of a service provision system consistent with one aspect of the invention may comprise: a plurality of user accommodation apparatuses each having a unit for connecting with a terminal of a user to provide a service to the user, the user's copy of an application program being held in the system; and a central apparatus having a unit for communicating with each of the plurality of user accommodation apparatuses. In this system, the central apparatus may manage first information indicating which one of the plurality of user accommodation apparatuses the user is currently associated with, and one of the plurality of user accommodation apparatuses, which the user is currently associated with, may hold second information for specifying where in the system the user's copy of each application program is held. Then, each of the plurality of user accommodation apparatuses may comprise: a unit that accepts a use request from a user of a terminal connected; a unit that determines which one of the plurality of user accommodation apparatuses the user whose use request is accepted is currently associated with, based on the first information; a unit that acquires the second information from the determined one of the plurality of user accommodation apparatuses; a unit that causes the user's copy of an application program designated by the user to move from one of the plurality of user accommodation apparatuses specified by the second information to the user accommodation apparatus concerned; and a unit that causes the user's copy of the designated application program in the user accommodation apparatus concerned to operate to communicate with the terminal.

An example of a service provision system consistent with another aspect of the invention may comprise: a plurality of user accommodation apparatuses each having a unit for connecting with a terminal of a user to provide a service to the user, the user's copy of an application program being held in the system; and a central apparatus having a unit for communicating with each of the plurality of user accommodation apparatuses. In this system, the central apparatus may manage first information indicating which one of the plurality of user accommodation apparatuses the user is currently associated with, and one of the plurality of user accommodation apparatuses, which the user is currently associated with, holds a portal program for the user. Then, each of the plurality of user accommodation apparatuses may comprise: a unit that accepts a use request from a user of a terminal connected; a unit that determines which one of the plurality of user accommodation apparatuses the user whose use request is accepted is currently associated with, based on the first information; a unit that causes the portal program for the user to move from the determined one of the plurality of user accommodation apparatuses to the user accommodation apparatus concerned; a unit that causes the portal program for the user in the user accommodation apparatus concerned to operate, causing second information for specifying where in the system the user's copy of an application program designated by the user is held to be referred to, and causing the user's copy of the designated application program to move from one of the plurality of user accommodation apparatuses specified by the second information to the user accommodation apparatus concerned; and a unit that causes the user's copy of the designated application program in the user accommodation apparatus concerned to operate to communicate with the terminal.

In the above service provision systems, the user accommodation apparatus holding the second information and/or the portal program may change and the first information may be rewritten such that there is only one user accommodation apparatus with which the user is currently associated among the plurality of user accommodation apparatuses. Further, the user's copy of the application program may move and the second information may be rewritten such that there is only one user accommodation apparatus holding the copy among the plurality of user accommodation apparatuses.

Consequently, a situation where portals and/or copies of an application for an identical user exist here and there in the system with their statuses being slightly different from one another can be avoided, and the resources of the whole system can be effectively utilized while ease of use is improved.

In the above service provision systems, the user's copy of each application program may be held in one of the plurality of user accommodation apparatuses with data and status information of the application program included, and information for charging for a service provided by an application program designated by the user may be collected from the user accommodation apparatus holding the user's copy of the application program to the central apparatus.

This may allow the central apparatus to manage the charging in a unified manner, and at the same time allow each user accommodation apparatus to autonomously control the move and execution of an application program. In addition, the user's own copy of an application program may include information on the status of the application. Consequently, for example, in a case where an application used by a user at one location has operated up to a step 1 and if the user moves to another location and designates the same application, the user's own copy of the application that has moved in to the user accommodation apparatus at that location can start operating from a step 2 that follows the step 1.

In the above service provision systems, the user accommodation apparatus holding the user's copy of the application program may have a unit for causing the copy to keep operating while not connected with the terminal of the user, and the movement of the user's copy of the application program is performed, causing the copy to keep operating while moving the copy.

Consequently, for example, in a case where an application used by a user at one location has operated up to a step 1, the application continues to operate and starts operating a step 2 that follows the step 1 even after the user left the location, and then if the user moves to another location and designates the same application, the user's own copy of the application continues to operate (continues to execute the step 2) and moves to the user accommodation apparatus at that location, so the user will be able to confirm that a step 3 that comes further after the step 2 is operating. Applications that continue to operate while not communicating with a user terminal as above include, for example, a character raising game, and rendering software that requires considerable processing time.

A portal program for a user may also be made to continue to operate even while the user does not exist at any location, and to continue to operate while being moved to the location to which the user went next.

In the above service provision systems, virtual middleware may be installed in each of the plurality of user accommodation apparatuses, such that the user's identical copy of each application program can operate in any one of the plurality of user accommodation apparatuses.

This may allow virtualization technology to be used to move an application program between user accommodation apparatuses.

In the above service provision systems, each of the plurality of user accommodation apparatuses may further comprise a unit for connecting with another of the plurality of user accommodation apparatuses not via the central apparatus.

This may allow each user accommodation apparatus to control the move of a portal for a user or the user's own copy of an application program more autonomously without dependence on the central apparatus.

The principle of the invention may also be realized by methods performed by each user accommodation apparatus comprised in a service provision system, or by a method performed by the whole service provision system. The principle of the invention may further also be realized by a program for causing a computer or a group of computers to function as each apparatus or as the system, or by a recording medium on which such program is recorded.

An example of a method of providing a service to a user consistently with the invention may comprise: configuring the system to hold the user's copy of an application program; locating in the central apparatus first information indicating which one of the plurality of user accommodation apparatuses the user is currently associated with; causing a user accommodation apparatus among the plurality of user accommodation apparatuses that has accepted a use request from a user of a terminal to determine which one of the plurality of user accommodation apparatuses the user is currently associated with based on the first information, and to use the determined one of the plurality of user accommodation apparatuses to obtain second information for specifying where in the system the user's copy of an application program is held; moving the user's copy of an application program designated by the user from one of the plurality of user accommodation apparatuses specified by the second information to the user accommodation apparatus that has accepted the use request; and causing the user accommodation apparatus that has accepted the use request to operate the moved user's copy of the application program to communicate with the terminal.

An example of computer readable program codes to be incorporated into a computer system, whereby the computer system functions as a service provision system consistent with the invention, may comprise: program codes for configuring the system to hold the user's copy of an application program; program codes for locating in the central apparatus first information indicating which one of the plurality of user accommodation apparatuses the user is currently associated with; program codes for causing a user accommodation apparatus among the plurality of user accommodation apparatuses that has accepted a use request from a user of a terminal to determine which one of the user accommodation apparatuses the user is currently associated with based on the first information, and to use the determined one of the plurality of user accommodation apparatuses to obtain second information for specifying where in the system the user's copy of an application program is held; program codes for moving the user's copy of an application program designated by the user from one of the plurality of user accommodation apparatuses specified by the second information to the user accommodation apparatus that has accepted the use request; and program codes for causing the user accommodation apparatus that has accepted the use request to operate the moved user's copy of the application program to communicate with the terminal.

As described above, the invention can realize a service provision system with a plurality of distributed servers to provide an application service, allowing a user to use an identical service provided by the system whichever location the user moves, while reducing delay between a user terminal and a running application.

### DESCRIPTION WITH REFERENCE TO DRAWINGS

Exemplary embodiments of the above-described configuration will be described below with reference to the drawings.

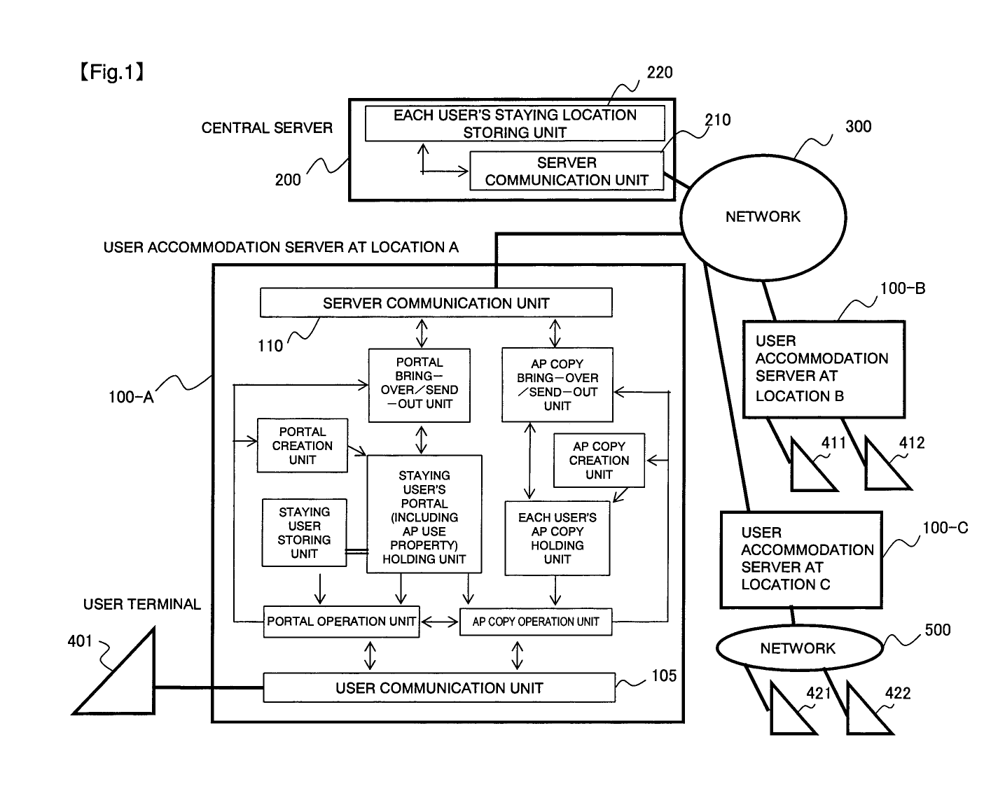

FIG. 1 shows a configuration example of a service provision system consistent with an embodiment of the invention. Locations A to C are installed with user accommodation servers 100-A to 100-C, respectively, each of which is connected to a network 300 through a server communication unit 110. A central server 200 is also connected to the network 300 through a server communication unit 210, and each user accommodation server 100 and the central server 200 can communicate with one another.

While in this example the common network 300 allows servers to communicate with one another, a tree-structure network with a central server being the root and each user accommodation server being a leaf can be adopted as another example. In that case, user accommodation servers may communicate with one another via a relay server that corresponds to a branch of the tree structure, or may communicate with one another in a second network that is provided separately from the tree-structure network. Various networks can be used as the network in the embodiments, such as the Internet, the Next Generation Network (NGN), high-speed Gigabit Ethernet, and an IP-CATV network.

Each of user terminals 401 to 422 connected to the above service provision system connects to a user communication unit 105 of the user accommodation server 100 at one of the locations directly or via a network 500. A user of the service provision system can connect a user terminal (which may be a terminal that the user carries around, or may be a terminal that is lent at the location) to the user accommodation server 100 at a place where the user currently exists or near that place to receive an application service.

The central server 200 stores in an each-user staying location storing unit 220 and manages information indicating at which location each user of the service provision system is currently receiving a service (if a user is not currently connected, at which location the user was most recently receiving a service).

The above service provision system can also be configured as a service platform using virtualization technology (e.g. see “Nikkei BP Mook: Subete wakaru kasouka taizen (Nikkei BP magazine book: All About Virtualization)” (edited by ITPro, published in Oct. 30, 2006 by Nikkei Business Publications, Inc.)). In that case, each user accommodation server and the central server are configured such that they are installed with virtual middleware (e.g. VMware Server, VMware ESX Server, or VMware Infrastructure of VMware, Inc., Virtual Server of Microsoft Corporation, Xen of XenSource Inc., and the like) on their OSs, and that each function in the embodiments described is implemented on the virtual middleware.

If virtual middleware is installed in a computer (server), an identical program can run on the virtual middleware no matter what hardware, firmware, or OS (host OS) is adopted by the computer. In addition, resources can be managed for each individual application. Moreover, the virtual environment where virtual middleware is installed on every server allows an application program to continue to operate while moving between servers.

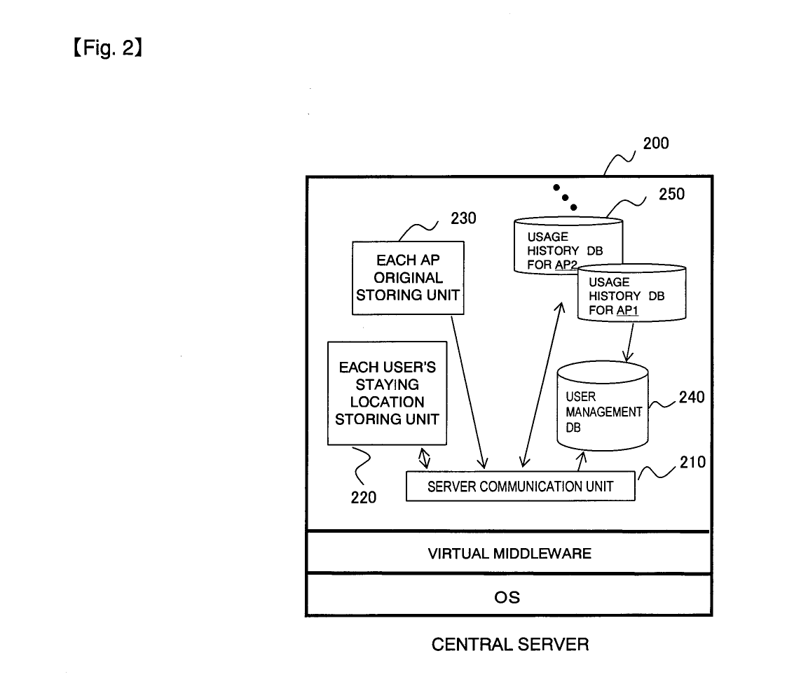

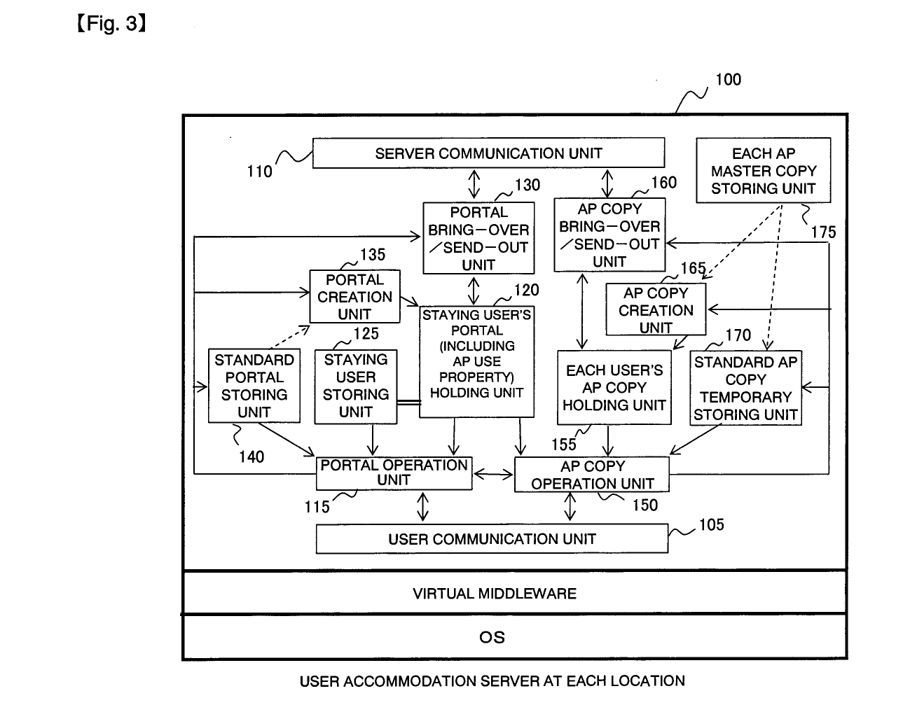

FIGS. 2 and 3 show examples of the central server and each user accommodation server, respectively, configured as described above.

The central server 200 in FIG. 2 has functions, such as an each application (hereinafter referred to as “AP”) original storing unit 230, a user management database (hereinafter referred to as “DB”) 240, and an AP-by-AP usage history DB 250, in addition to the server communication unit 210 and the each-user staying location storing unit 220.

In this example, an original of each AP is collected and stored in the each AP original storing unit 230 of the central server. Alternatively, as another example, they may be distributed among several user accommodation servers and stored there (e.g. in a user accommodation server near an original's provider).

The user management DB 240 is a master DB for user management which is solely provided in the center, and stores information on each user that has signed up for a service system of the embodiment. One that is not registered in this DB cannot be a user of the service provision system. When a user attempts to sign in to a user accommodation server at one location in order to receive an application service, a check against the information of the user management DB 240 of the central server is made, so that approval or disapproval of the use can be determined. The user management DB 240 may store information for charging a user for compensation for a service provision (e.g. information indicating what kind of AP was used for how long).

The AP-by-AP usage history DB (usage log DB in a computer system) 250 can store a usage record on an AP-by-AP basis for each user that uses the AP concerned. For example, information on how many hours a user used the AP, which function of the AP the user used, or the like is recorded every time the user finishes using the user's own copy of the AP. The recorded user-by-user usage information may be fed back to the provider of the original of the AP, or may be processed at an appropriate time for charging and collecting and be reported to the user management DB 240. The appropriate time is, for example, a time when usage information is written to the AP-by-AP usage history DB 250, a time when a prescribed amount of usage information is accumulated in the AP-by-AP usage history DB 250, every time a prescribed time period passes by, or the like.

If the charge of the service provision system to a user is, for example, a flat fee regardless of usage, the report from the AP-by-AP usage history DB 250 to the user management DB 240 is not required. However, in a case of a usage-based charge based on utilization time, on the amount of occupied resources (CPU and memory), or the like, or in a case of a charge that changes depending on a function used, on the time of use, or the like, information for charging is desirably collected from the AP-by-AP usage history DB 250 to the user management DB 240.

The AP-by-AP usage history DB 250 may also store, on an AP-by-AP basis for each user that uses the AP concerned, information (CONFIG information) indicating minimum configuration requirements required when the user next uses the user's own copy. The CONFIG information is recorded by writing information on resources for the user's copy of the AP when the user finishes using it (how much memory the resumption of the operation of the user's copy of the AP requires, a required CPU occupancy rate, priority over other APs, and the like, based on the status at the time of finish).

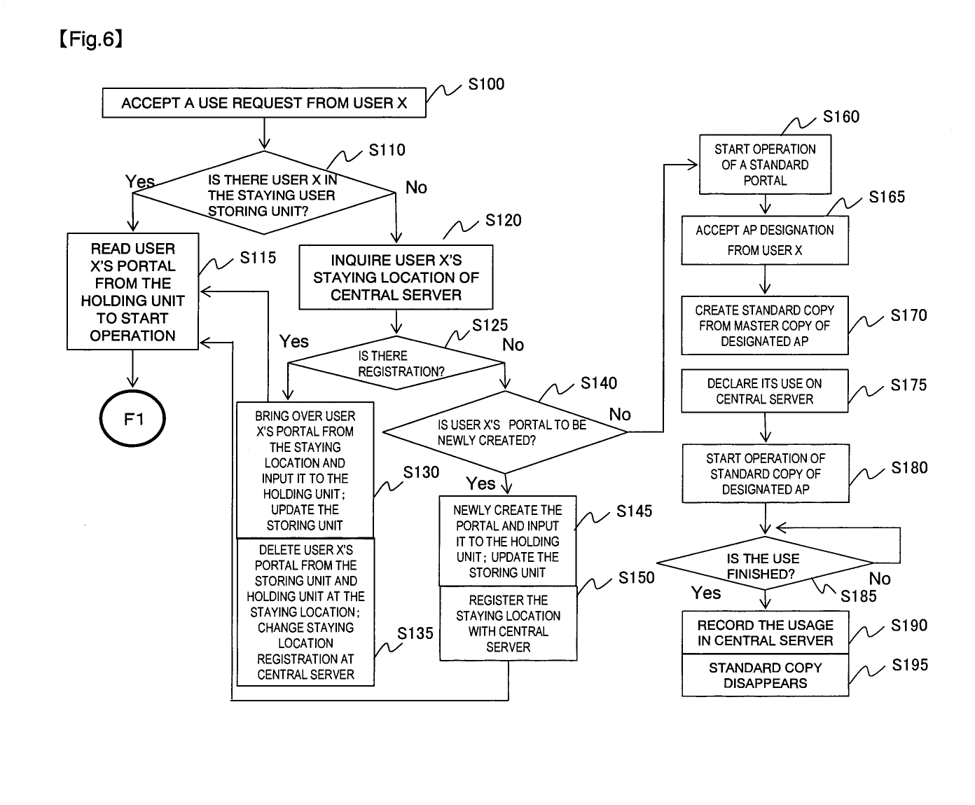

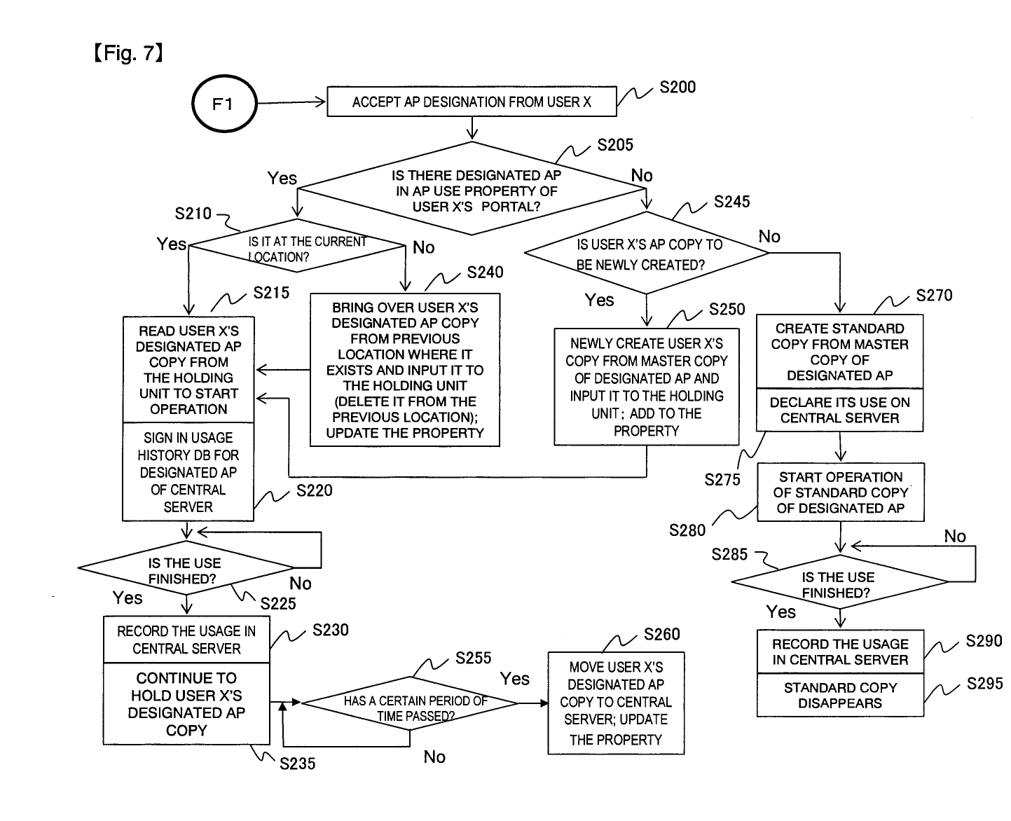

The user accommodation server 100 in FIG. 3 has various functions to bring over, as required, portal programs for each user that are distributed in user accommodation servers at a plurality of locations and a user's own copy of an application, in addition to the server communication unit 110 and the user communication unit 105. The operation of each functional part will be described later with descriptions of flowcharts in FIGS. 6 and 7.

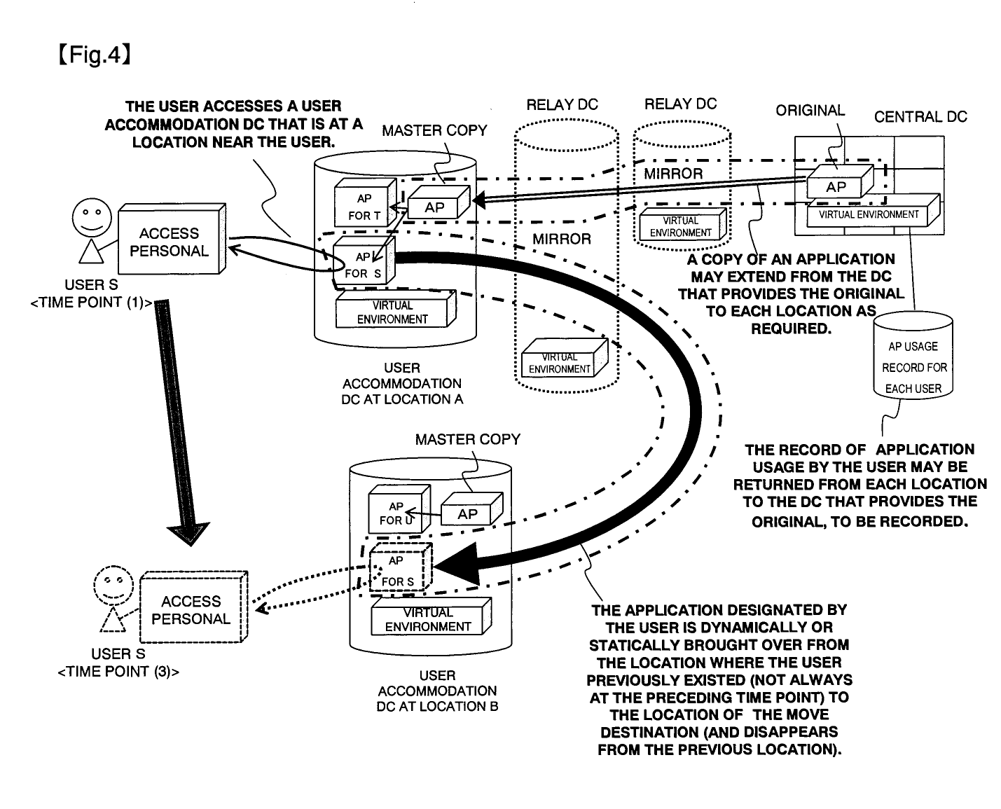

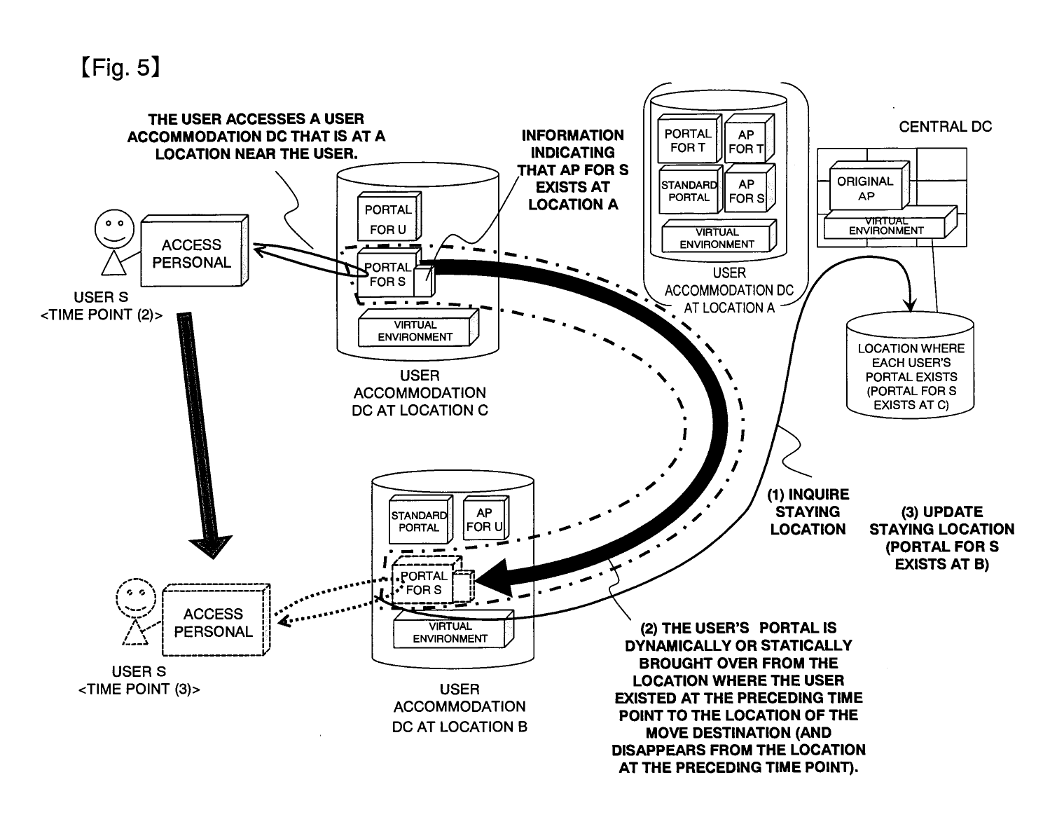

FIGS. 4 and 5 illustrate how a user's own copy of an application and a portal for a user, respectively, move to the location of the user's move destination in a service provision system consistent with an embodiment of the invention.

In this example, the user accommodation server 100 at each location and the central server 200 are each configured as a data center (hereinafter referred to as a “DC”). A DC may be made up of a single server, or of a group of servers, group of storages, network devices, or the like that are brought together at one location. For example, an Internet operator, a cable TV operator, a fixed phone operator, a mobile phone operator, or the like may be an operator of each DC, and operators may be different from DC to DC. DCs can be connected with one another through various networks as described above, or an exclusive line may be laid between at least a part of them.

There may be one or more relay DCs between the central DC and a user accommodation server, and between user accommodation servers. A relay DC relays a message transmitted and received between DCs on both ends, or helps an application copy or a portal move. This function of a relay DC can also be implemented on the virtual environment where virtual middleware is installed on the OS.

A DC from which an application copy or a portal moves and a DC to which it moves, with a relay DC included if there is any therebetween, may communicate in synchronization with one another as required so that they form one virtual space.

A copy of an application program that moves on the virtual space may be a virtual machine (program) into which a guest OS of server virtualization technology and the application program are integrated, or may be solely an application program. In the former case, an application copy can be moved from a move origin DC to a move destination DC, for example, in the form of Virtual Appliance of VMware, Inc.

An end user can connect to the service system of the embodiment in all places by, for example, carrying the user's own small equipment called an access personal and moving between each location. An access personal is provided with a function to authenticate a person and a communication connection function, and has an end-user-side terminal and a network-side terminal. The end-user-side terminal is connected with equipment having a user interface (the equipment may be a personal computer, a telephone headset, or a TV set-top box, and may be the user's own equipment or one that is borrowed there). The user terminal comprising the above user interface equipment and the access personal will be connected to a user accommodation DC at a location concerned via the network-side terminal.

An application program to provide a service to an end user will not be downloaded to a user terminal, but its copy is in a user accommodation DC at a location near the user, so the user will come in contact with the application over a network. This allows a user to use a service in the same way even if the user interface equipment changes, and can achieve universal use.

The original of an application is not in a user accommodation DC accessed by a user, but in the central DC or in the DC that provides the original. A master copy, as a copy of the original, is created in a user accommodation DC at a location determined to provide a service using the application.

In a case where the central DC and a user accommodation DC, with a relay DC included if there is any therebetween, form one virtual space, a master copy of an application may be caused to move on the virtual space, being mirrored by a relay DC if there is any therebetween. An advantage of causing an application program to extend over virtual space from the central DC to a user accommodation DC as above is that while the original program remaining in the central DC continues to operate, the master copy program can be delivered to the user accommodation DC, continuing to operate as well.

Of course, the master copy program may be downloaded as a file from the central DC to the user accommodation DC, or may be delivered on a storage medium such as a CD-ROM.

The above master copy will be a copy origin AP at each location. Two kinds of AP copies can be generated from the master copy. One is a standard copy that is generated only while being used by a user and disappears when the use is finished, and the other is a personal copy that is held for a user even after the user finishes using it and can be used again at the next use.

A master copy, like the original, has only data and status that are common to all users, while a personal copy holds data and status of a program that can be different depending on each user that operates the application.

Therefore, a master copy comprises, for example, an application program, data used by the program, and initial values of the statuses of the program and data. On the other hand, each user's own copy comprises, for example, an application program, data created and data being used by the user in the program, and current values of the statuses of both the program and data for the user. The current values of the statuses can be made to dynamically indicate the progress of the program and, for example, can be made to always dynamically indicate what point the program has progressed to and what status number it has been running to or is currently running in.

In the example in FIG. 4, a user S at a time point (1) has accessed a user accommodation DC at a location A, has made the user's own copy of a certain AP, and is using it. At a time point (3) after that, suppose the user S has moved to a location B and desires to use again the AP that the user S was using at the time point (1). Then, in the embodiment, the user S's own AP copy, which has been held in the user accommodation DC at the location A as it was since it was used at the time point (1), is brought over and thus moves to the user accommodation DC at the location B.

The AP copy desired by the user at the time point (3) is not necessarily held at a location where the user existed at the preceding time point (2). In the example shown in the figure, the AP copy is held at the location where the user existed at the further previous time point (1), and is brought over from there.

In this regard, services provided by each AP in the embodiment may include various ones, such as business processing software, a software development tool, and the like. Among those, there may be: applications that progress at a user's own pace, such as writing texts and drawing pictures; applications that involve a time-consuming process to be done by a computer alone, such as a simulation and rendering; applications in which the status changes with time, such as a character raising game; or applications, such as an online fighting game involving interaction that requires high-level real-time properties, and video delivery with a questionnaire added with the provision of a commercial that changes with time. The process of moving an AP copy between DCs may be performed statically or dynamically in accordance with the properties of those various applications.

A static move can be performed when the operation of an AP copy in a move origin DC has already been finished. Even when the copy is in operation, if it can be stopped temporarily, a static move can be performed by finishing the operation. A static move involves: creating a file of an AP copy that includes data and status values of the AP copy at the operation's end and the program; and transmitting the file to a move destination DC. When the transmission is complete, the AP copy is deleted from the move origin DC. In the move destination DC, the program is taken out of the received file, the data and status values also taken out of the received file are inputted to the program, and thus the operation of the user's own AP copy is resumed.

A dynamic move is required in order for an AP copy to continue the operation while moving from a move origin DC to a move destination DC. This can be achieved, for example, by using VMotion of VMware, Inc. or the live migration function of Xen. In a dynamic move, a copy of the AP copy is created step by step in the move destination DC without the AP copy that is operating in the move origin DC being stopped; when a complete copy is made, the control right moves from the AP copy in the move origin DC to the copy of the AP copy in the move destination DC; and after that the AP copy in the move origin DC is deleted.

In a case where a dynamic move is made with a relay DC put in the middle, a copy of an AP copy is created step by step in the relay DC with the AP copy in a move origin DC caused to continue to operate; when a complete copy is made, the control right moves from the AP copy in the move origin DC to the copy of the AP copy in the relay DC; and after that the AP copy in the move origin DC is deleted. The same process is then repeated on downstream DCs based on the AP copy operating in the relay DC, finally producing the AP copy in the move destination DC, which obtains the control right.

The mechanism in FIG. 4 allows, for example, a user of a recorded video viewing service to push a “stop” button halfway through a movie that the user has been watching at the user's home and after that to resume watching the same movie from the stop point at a hotel in a business trip destination. This is carried out by the program used by the user for the watching and contents data of the movie moving from a user accommodation DC which a terminal in the user's home was connected with to a user accommodation DC which a terminal in the hotel is connected with, with information on the stop point (status values at that time) which is effective only for that user.

For another example, if a user of an online gaming service in which an egg is raised disconnects the connection at the user's home in a condition where the user has advanced the game up to “three days before hatching” and if the user accesses the same game at an acquaintance's house of a trip destination the next day, the user can see that the user's egg has grown up to two days before hatching. This is carried out by the program of the raising game and information, which changes with time, on the user's egg (status values at that time) moving, from a user accommodation DC which a terminal in the user's home was connected with to a user accommodation DC which a terminal in a trip destination is connected with, with the program continuing the operation.

For still another example, if a user of a 3D drawing service runs on a previous day a coloring process (rendering) of an animation under creation from a personal computer in the drawing company and if the user sees the progress of the coloring software the next morning from a terminal in the editing company, the user can make sure that the process is finished and the animation is colored. This is carried out by the process being continued even after the connection is disconnected in a user accommodation DC which the personal computer in the drawing company was connected with, and by the 3D drawing software program and data and status values, at the completion of the process, of the animation under creation moving from that user accommodation DC to a user accommodation DC which the terminal in the editing company is connected with.

As above, from the viewpoint of a user, an application for each user (such as program data, a system, and a website) can be used under the same conditions (the user's own conditions) regardless of time, place, or terminal. Even if an application that was used in one location is moved to another location, the user can use it as if the user continued to use it in a previous location (under the same conditions, service contents, charge, appearance, or the like). Moreover, since a user's own application copy itself moves to a user accommodation DC near a place where the user currently exists, delay between the user and the application is short, and even an interactive application service can be smoothly provided.

In the embodiment shown in FIG. 5, a portal, which is an entrance (entry) to be accessed first when a user attempts to use an application, can be freely customized for the user, and the user's own portal can be made to move to the user's move destination location in such a way as to follow the movement of the user.

In the example in FIG. 5, the user S at the time point (2) has accessed a user accommodation DC at a location C, and is using an application service via the user's own portal. At the time point (3) after that, suppose the user S has moved to the location B and desires to use the service in the user's own use environment. Then, in the embodiment, the portal program for the user S, which has been held in the user accommodation DC at the location C as it was since it was used at the time point (2), is brought over and thus moves to the user accommodation DC at the location B. A portal program can also be accompanied by data and time-varying status values, and with them included, may be moved statically or dynamically.

A portal is an entrance for a user to access the service system of the embodiment, and two kinds of portals may be used. One is a standard portal that is identical for every user, and the other is a personal portal that can provide a unique use environment to each user.

A personal portal is accompanied by information on the use property of an individual. A standard portal does not have the use property of an individual. A portal for a user is accompanied by the use property of that user only. A set of a personal portal and AP property information of an individual may be configured such that a target and behavior description are made to move together as a process target, in an object-oriented manner.

Information on the use property of an individual includes, for example: a utility for customizing a portal itself to suit an individual; auxiliary functions such as a timer and an alert; a script (access method) for allowing a portal to be accessed in accordance with what user interface equipment (a personal computer, a telephone, a TV, or the like) an access terminal is connected with in what manner; an object forming a menu screen for a user to choose various services (a button-like 2D display menu, a Metaverse-like 3D display menu, a mobile-phone-like small screen display menu, or other menus whose contents are in the form of objects so that they can be commonly used regardless of display/output format of the equipment connected to the access personal at the user side); a widget tool, and the like.

Information on the use property of an individual accompanying a personal portal may include information on an AP use property that indicates which AP the individual user is using, which location the user's own copy of the AP is held in, and the like.

In FIG. 5, the user accommodation DC at the location B to which the user S has moved first inquires of the central DC the location last accessed by the user S (the location where the portal for the user S is held) in order to bring over the portal for the user S, upon request of the user S. As the central DC manages information indicating each user's staying location, it replies to the user accommodation DC at the location B that the user S is associated with the location C.

The user accommodation DC at the location B causes the portal for the user S to move from the user accommodation DC at the location C to the user accommodation DC at the location B, and allows the user S to use the user's own environment. At the same time, the portal for the user S is deleted from the move origin, i.e. the user accommodation DC at the location C. Then, the each-user staying location information in the central DC is rewritten such that it indicates that the user S is now associated with the location B.

The portal for the user S has, as an AP use property, information indicating that the user S's own AP copy is held at the location A, and therefore the user S's own AP copy can be brought over as illustrated in FIG. 4 via the portal for the user S that has been brought over as illustrated in FIG. 5.

As above, a set of functions required for running an application for each user exists as a continually-single portal in the service provision system, and can move to where it is used when it is used, while continuing to operate.

A portal can be provided, for example, in the form of a web page, and can also be provided in other various forms in a case where the user interface equipment may be a telephone or a TV. In order to be able to be used regardless of the kind of the equipment, a portal desirably has a function to transfer between itself and an access personal a menu, a guidance, data, and the like in XML or the like. In this case, a portal and use property information, as well as information indicating each user's staying location that is managed by the central DC, are created, for example, in an object description method such as Binary XML, BISON, or the like.

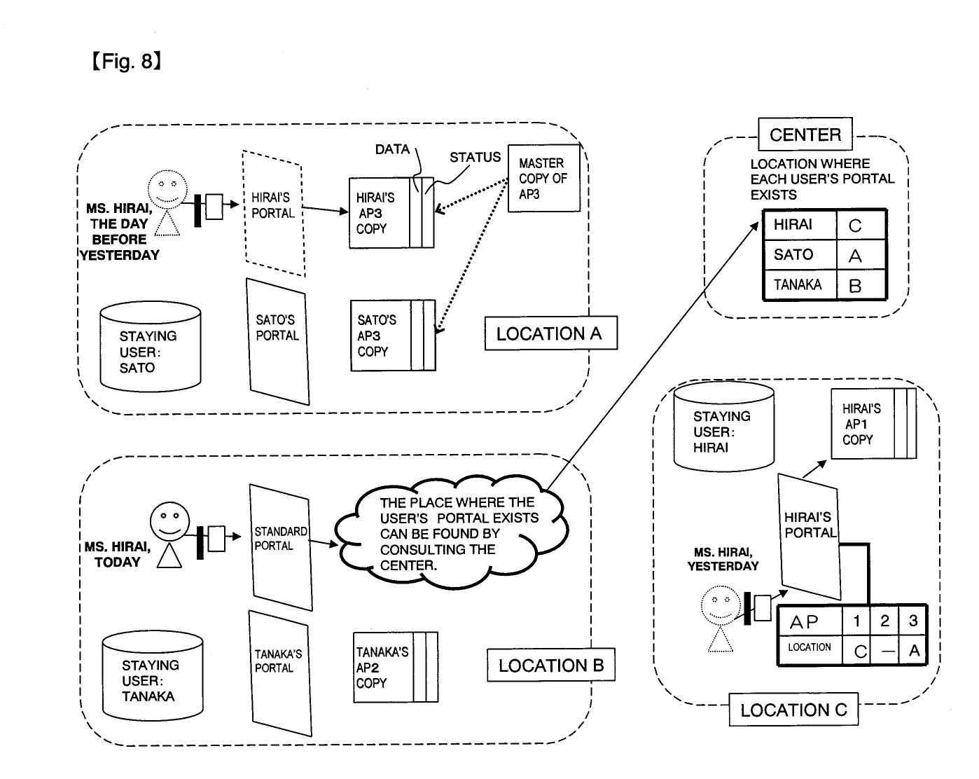

The following description is how a user accommodation server having an internal function configuration like FIG. 3 performs the operation shown in FIGS. 6 and 7 to provide a service to a user, and is also made with reference to FIGS. 8 to 10. Locations A, B, and C are apart geographically or from the viewpoint of a network, but are all comprised in a service system consistent with the embodiment and controlled by an identical center.

First, when a user (Ms. Hirai, in this example) attempts to use a service at a location (the location B, in this example), a portal operation unit 115 of a user accommodation server at the location B accepts a use request (S100).

The process branches depending on whether or not Ms. Hirai's own portal exists at the location B where the use request has been accepted (S110). When the personal portal exists (stays) at the location, the name of the user concerned, the user ID, or the like is recorded in a staying user storing unit 125 at the location.

If the personal portal does not exist at the location (No at S110), the user will use a standard portal, and the portal operation unit 115 of the user accommodation server reads a portal program, data, and the like from a standard portal storing unit 140 and executes the program. The portal operation unit 115 also receives an instruction from a user terminal or performs display/output on the user terminal, via the user communication unit 105.

The standard portal inquires of the central server the staying location of the user (S120). Consequently, if the user's own portal is already created at any location other than the location where the user currently exists (if the user has moved from a location where the user's own portal is held to another location), the user can instruct the system to move the user's own portal from the staying location to the user accommodation server at the current location. In a case where a user's own portal is already created, the user has signed up for the service system of the embodiment as a user (the user's user ID is registered in the user management DB 240) and the user's own portal is already created (the user's user ID is stored in the each-user staying location storing unit 220 with the user ID being associated with some location).

The example in FIG. 8 shows a case in which Ms. Hirai, who was using her own copy of AP1 via her own portal at the location C until yesterday, moves to the location B and accesses the service system of the embodiment. At the location B of the move destination, Ms. Hirai connects using the same access personal as the one she was using at the location C.

The user accommodation server at the location B consults the staying user storing unit 125. However, Ms. Hirai's user ID is not recorded since Ms. Hirai's portal does not exist, and a standard portal is displayed. At this point, if the user Ms. Hirai chooses an instruction saying “Bring over my portal” from the menu in the standard portal, the user accommodation server at the location B inquires of the central server the location where Ms. Hirai's portal is held.

The each-user staying location storing unit 220 of the central server stores the location C where Ms. Hirai most recently existed (Yes at S125). Therefore, obtaining a reply to the inquiry from the central server, the user accommodation server at the location B can bring over Ms. Hirai's portal program from the location C where it stays to the current location B (S130).

Specifically, a portal bring-over/send-out unit 130 at the location B transmits an inquiry to the central server via the server communication unit 110, transmits a move request for Ms. Hirai's portal to the location C if required, receives the transmitted portal for Ms. Hirai, and stores it in a staying users' portal holding unit 120. When the reception is complete, Ms. Hirai's user ID is stored also in the staying user storing unit (S130). The central server is notified to change Ms. Hirai's staying location to B (S135).

On the other hand, the portal bring-over/send-out unit 130 at the location C receives from the central server or the location B via the server communication unit 110 a message to move Ms. Hirai's portal to the location B, and sends out Ms. Hirai's portal stored in the staying users' portal holding unit 120 toward the location B. After the move to the location B is complete, Ms. Hirai's portal is deleted from the staying users' portal holding unit 120, and Ms. Hirai's user ID is deleted from the staying user storing unit 125, at the location C (S135).

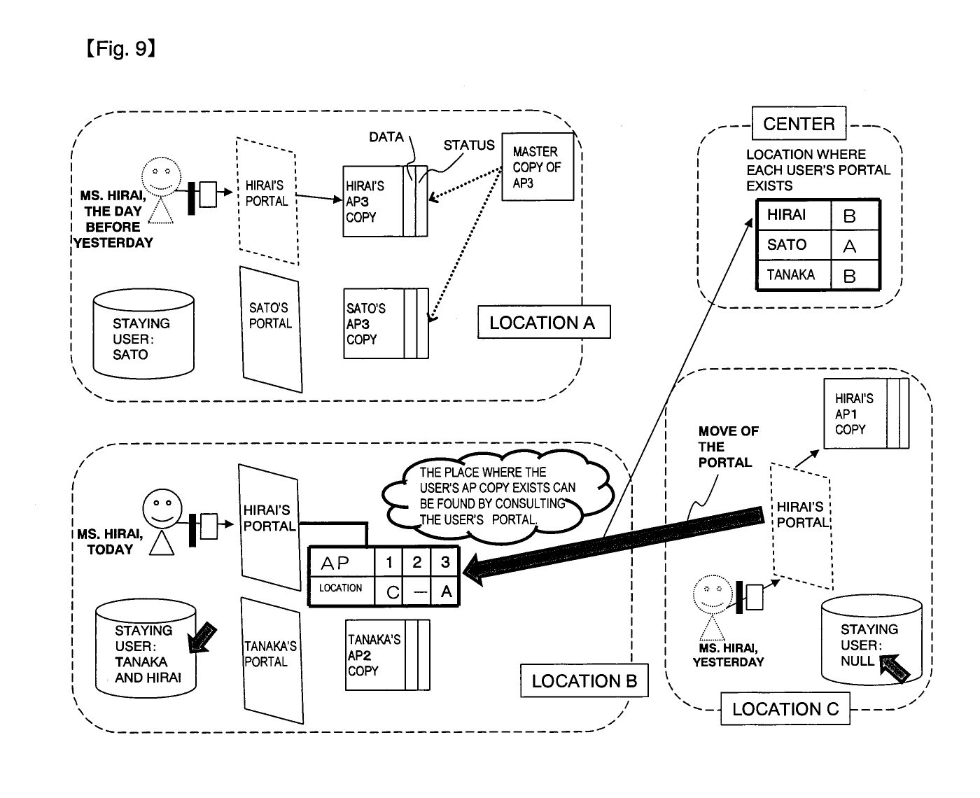

The above operation is illustrated in FIG. 9 as follows: the portal is moved to the location B; the same portal at the location C is deleted; Ms. Hirai's staying location is rewritten from C to B in the each-user staying location storing unit 220 of the central server that received a move completion notification from the location B; Ms. Hirai's user ID is deleted from the staying user storing unit 125 at the location C where Ms. Hirai previously existed; and Ms. Hirai's user ID is added to the staying user storing unit 125 at the current location B.

After that, in the user accommodation server at the location B, the portal operation unit 115 reads and executes the portal program, data, and the like, that have moved and been stored in the staying users' portal holding unit 120 (S115). This allows the screen of Ms. Hirai's user terminal to be rewritten from the standard-use portal screen to the personal-use portal screen.

As above, when a portal for a user moves between locations, information on the use property of the user also moves together. The user can use both a standard copy of an AP and the user's own AP copy via the user's own portal as described later.

The move of the portal from the location C to B may be carried out in a configuration in which the user accommodation server at the location B obtains a reply from the central server and makes a request anew on its own to the location C for the move of the portal, or in a configuration in which the central server that received the inquiry directly instructs the user accommodation server at the location C to move Ms. Hirai's portal to the location B instead of making a reply to the user accommodation server at the location B. Either configuration is included in the scope of the present invention.

If the portal for the user proves not to exist at other locations as a result of the standard portal inquiring of the central server the staying location of the user (No at S125) and if the user's own portal is desired to be created on the spot (Yes at S140), the user's own portal can be newly created.

A state where a user's own portal does not exist in any location is a state where the user has signed up for the service system of the embodiment as a user (the user's user ID is registered in the user management DB 240) but the user's own portal is not yet created. The user can access a standard portal and use a standard copy of an AP even in the above state but, when the user finishes using the standard copy, it will not remain as a software entity and will disappear.

So, the embodiment provides creation of a user's own portal aside from a standard portal. Only one portal can be created for each user in the service system of the embodiment, and the user's own portal can be used at different locations in the service system. For this purpose, a user accommodation server that has been accessed by a user inquires of the central server to confirm that the user's ID is not stored in the each-user staying location storing unit 220 (is not associated with any location), before newly creating a portal for the user.

Then, a portal creation unit 135 of the user accommodation server creates the user's own portal by generating the user's use property information and causing it to accompany the portal program stored in the standard portal storing unit 140, and causes the staying users' portal holding unit 120 to store the user's own portal (S145). The staying user storing unit 125 is caused to store the ID of the user whose portal is created (S145). For example, in FIG. 8, if a portal for Mr. Sato is newly created at the location A, the user accommodation server at the location A adds Mr. Sato's ID to the staying user storing unit 125, and sends a notification to the central server so that the each-user staying location storing unit 220 of the central server stores Mr. Sato's staying location being A (S150).

In the above example, if the user's own portal does not exist at the location where the use request is accepted (No at S110), the operation of the standard portal is started. Alternatively, the operation of the standard portal may be started (S160) when the user instructs that the user's own portal should not be used (e.g. No at S140).

With the order of S120 and S140 in FIG. 6 being reversed, the inquiry on whether the user's staying location is stored in the central server or not may be made (if it is not stored, the flow enters the process of newly creating a portal) when the user instructs to use the user's own portal (but the user's own portal does not exist at the current location). This can eliminate the inquiry to the central server when the user instructs not to use the user's own portal, and then the flow can immediately go to the designation of the user's desired AP (the standard copy, in this case).

Whatever the case may be, when the user's own portal does not exist at the current location and the user's own portal being at another location is not to be moved, or when the user's own portal does not exist anywhere in the service system, only the standard portal can be used. A standard copy of an AP can be used but a personal AP copy cannot be used via the standard portal.

When the user accommodation server accepts the designation for the user's desired AP via the standard portal (S165), an AP copy operation unit 150 stores in a standard AP copy temporary storing unit 170 a standard copy of the designated AP generated from an each AP master copy storing unit 175 (S170). Then, in order to preserve a usage record in the central server, the AP copy operation unit 150 declares the user's use on the central server via the server communication unit 110 (S175). Specifically, the AP copy operation unit 150 signs in (logs in, or the like) the user management DB 240, and the central server starts use management.

In the user accommodation server, the AP copy operation unit 150 reads and executes the program and data stored in the standard AP copy temporary storing unit 170 (S180). When the user finishes using the standard AP copy at the location where the user currently exists (Yes at S185), the user accommodation server records the usage data in the user management DB 240 of the central server (S190). The usage data to be recorded, in actual operation, can be related to charging. For example, the data may be the type and name of the AP, the time spent to use the AP, the type of the used function and the number of times or frequency the function was used, the number of packets or other volume of communication, the amount of used resources (CPU, memory, and the like), and the like.

After the use is finished, the standard copy of the AP (alias) disappears and is not preserved or reused (S195).

If the personal portal exists at the current location (Yes at S110), the portal is automatically displayed, via which the application can be used (FIG. 7 following S115). As described above, this is also the case when the personal portal existed at another location and has been moved to the current location, or when the personal portal did not exist at any location and has been newly created at the current location.

Specifically, when the user accommodation server at the location where the user currently exists accepts the designation for the user's desired AP via the user's own portal (S200), the AP copy operation unit 150 refers to the user's AP use property held in the staying users' portal holding unit 120 (S205).

In the example in FIG. 9, Ms. Hirai's AP use property accompanying Ms. Hirai's portal that has moved from the location C to the location B shows that Ms. Hirai's own copy of AP1 exists at the location C, that only a standard copy is used for AP2 (Ms. Hirai's own copy does not exist), and that Ms. Hirai's own copy of AP3 exists at the location A.

This state corresponds to a case where, for example, Ms. Hirai was using her own copy of AP3 via her own portal at the location A the day before yesterday, moved yesterday to the location C and used her own copy of AP1 via her own portal, and has moved today to the location B and has accessed the service system of the embodiment. Ms. Hirai's portal has moved from the location A to the location C in yesterday's operation since she brought over her own portal in order to use her own AP copy, while her own copy of AP3 remains at the location A where she used it the day before yesterday since she did not use AP3 yesterday.

Even if Ms. Hirai's portal is brought over from the location C to B in today's move, Ms. Hirai's copies of AP1 and AP3 are still held at the locations C and A, respectively, and will not move to the location B if there is no action.

In the above situation, if Ms. Hirai designates AP3 as a desired AP, the user accommodation server at the location B refers to the AP use property of Ms. Hirai's portal and finds that Ms. Hirai's copy of AP3 does not exist at the location B itself but exists at the location A (No at S210). Then, the AP copy operation unit 150 causes an AP copy bring-over/send-out unit 160 to transmit a move request for Ms. Hirai's copy of AP3 to the user accommodation server at the location A via the server communication unit 110.

The AP copy bring-over/send-out unit 160 at the location A receives from the location B via the server communication unit 110 the message to move Ms. Hirai's copy of AP3 to the location B, and sends out Ms. Hirai's copy of AP3 stored in an each user's AP copy holding unit 155 toward the location B. After the move to the location B is complete, Ms. Hirai's copy of AP3 is deleted from the each user's AP copy holding unit 155 at the location A.

The AP copy bring-over/send-out unit 160 at the location B receives Ms. Hirai's copy of AP3 that has transmitted, and stores it in the each user's AP copy holding unit 155 (S240). When the reception is complete, the location of AP3 in Ms. Hirai's AP use property stored in the staying users' portal holding unit 120 is changed from A to B (S240).

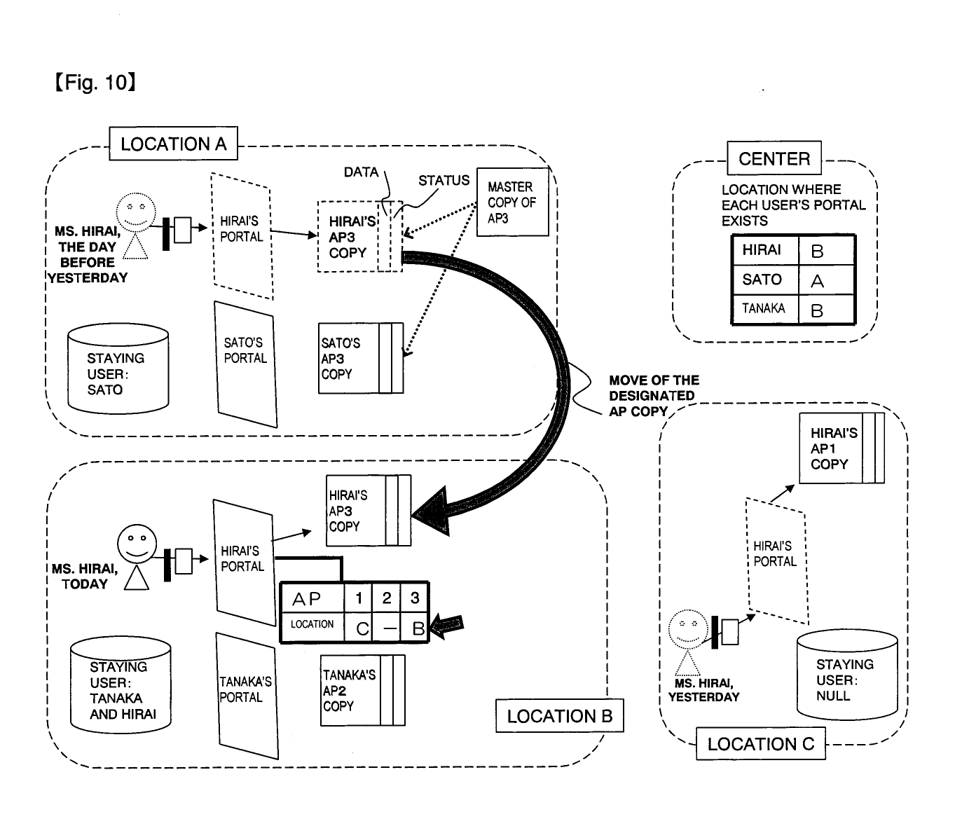

The above is shown in FIG. 10, where Ms. Hirai's AP3 copy has been moved to the location B, Ms. Hirai's same AP3 copy at the location A has been deleted and, at the location B, the AP use property accompanying Ms. Hirai's portal has been rewritten such that it indicates that Ms. Hirai's copy of AP3 exists at the location B.

Then, in the user accommodation server at the location B, the AP copy operation unit 150 reads and executes the program, data, and the like, of Ms. Hirai's AP3 copy that has moved and been stored in the each user's AP copy holding unit 155 (S215). This allows AP3 to be displayed on the screen of Ms. Hirai's user terminal as an available AP through Ms. Hirai's portal, and to be used actually.

A personal AP copy includes data and initial values in addition to the program, and these may include, for example, the statuses of the program and data of AP at the end of use, a pointer to created data, information required for matching logical information on the virtual environment to the lower-level physical environment, and the like. In a case where a user's own AP copy is continued to operate even after the user leaves the current location, the statuses at the end of use to be held may not be the statuses at the time when the user disconnects the connection, but be the statuses at the time when the continued operation is finished. Moreover, in a case where a user's own AP copy is continued to operate while moving, the status of the current continued operation may be included.

As described above, in the embodiment, even if there is neither personal portal nor personal AP copy at first at a location to which a user has moved, each of those that exist at another location can be brought over and used.

If the user has the user's own portal but does not have, for example, the user's own copy of AP2 (No at S205) and if the user desires to make the user's own AP2 copy (Yes at S245), the AP copy operation unit 150 at the location concerned signs in the usage history management DB 250 for AP2 of the central server and records therein a use start request, as required. As a result, the user's personal (Ms. Hirai's own, in this example) recording area is generated and reserved in the usage history management DB 250 for AP2.

At the location B where Ms. Hirai currently exists, an AP copy creation unit 165 generates Ms. Hirai's copy from the master copy of AP2 that exists in the each AP master copy storing unit 175, and stores it in the each user's AP copy holding unit 155 (S250). After that, the location for AP2 in Ms. Hirai's AP use property stored in the staying users' portal holding unit 120 is changed from null to B (S250).

As above, in either case where a personal copy of a designated AP is newly made or where a personal copy of a designated AP exists at the current location (Yes at S210), the program, data, and the like of the personal copy of the designated AP stored in the each user's AP copy holding unit 155 are read and executed by the AP copy operation unit 150 (S215).

At the use of a personal copy of a designated AP (Ms. Hirai's copy of AP3, in this example), the AP copy operation unit 150 at the location B may declare the user's use on the central server via the server communication unit 110 in order to preserve a usage record in the central server (S220). Specifically, signing in onto the usage history DB 250 for the designated AP is performed.

When the user finishes using the user's own AP copy at the location where the user currently exists (Yes at S225), the user accommodation server records the usage data in the AP-by-AP usage history DB 250 of the central server (S230). The usage data can be related to charging, as described above.

At the end of the use of the user's own AP copy, the above described CONFIG information may be recorded, instead of or in addition to the usage data, in the usage history DB 250 for the designated AP. In that case, when the user's own AP copy is started to be used next time, the user signs in onto the usage history DB 250 for the designated AP, and then the user accommodation server that is to operate the user's own AP copy from now on refers to the recorded CONFIG information and prepares an environment that at least meets the conditions. In the case where a user's own AP copy is continued to operate and moved from another location, the CONFIG information may be used in order to reserve resources required in a path on the route.

Reserving prescribed resources prior to operating an AP copy in this way is particularly effective in a virtual environment. For a virtual environment, the declaration of occupation of prescribed resources may be a declaration of allocations of a CPU, memory, hard disk, and the like, at their maximum use; and if their operational statuses do not actually reach the maximum, the resources can be shared with another service.

Then, the user's own copy of the designated AP does not disappear but is held even after the end of use (S235). For this reason, if the user does not use an AP for a long period of time, the user's own copy of the AP is continued to be held at a location where it was last used, without being used. An unused personal AP copy remaining at different locations as above might be undesirable from the viewpoint of effective use of resources.

In order to avoid the above situation, there may be an operation scheme in which a personal AP copy that is not used after a certain period of time has passed (Yes at S255) is collected to the central server. In that case, the user's own AP copy is moved to the central server, and at the same time the AP use property information accompanying the user's own portal that exists at some location is rewritten (S260). Which location the user's own portal exists at when it is detected that the certain period of time has passed can be found by referring to the each-user staying location storing unit 220 of the central server.

Therefore, if a user's own AP copy whose certain period has passed is collected, for example, from the location B to the central server, the central server desirably requests the user accommodation server that currently holds the user's own portal to update the use property information such that the location of the AP collected to the central server is changed from B to the center. This will allow the stored user's own AP copy to be moved, at the time of reuse, from the central server to the location where the user currently exists.

While the above is a description of collection of a personal AP copy, a personal portal may also be collected to the central server and the each-user staying location storing unit 220 of the central server may update the information such that it indicates the center for the user, if the personal portal is not used for a long period of time.

In the above example, when a personal portal is moved, information of the each-user staying location storing unit 220 of the central server is rewritten; and when a personal AP copy is moved, AP use property information of the staying users' portal holding unit 120 at the location of the move destination is rewritten. However, other timing for rewriting may be adopted.

For example, in the embodiment, a personal portal and a personal AP copy can be used only by their user, which means while they are used at one location, they will not be brought over by another location. Therefore, a user's AP use property information may be rewritten when the use of a personal AP copy at a location of a move destination is finished. After that, the user's staying location information in the central server may be rewritten when the use of the personal portal at the location of the move destination is finished.

Either a standard copy or a personal copy of an AP may be made available to a personal portal according to a user's desire. Even if a user's own portal already exists at a location where the user currently exists, a standard copy of any AP can be used from the personal portal. In addition, a standard copy of a designated AP may be made available not only when the user's own copy of the designated AP does not exist and the user does not desire it to be newly made (No at S245), but also when the user's own copy exists but the user does not desire to use it.

The procedure for using an AP standard copy from a personal portal is the same as that from a standard portal. A standard copy generated from the master copy of the designated AP is temporarily stored (S270); the user's use is declared on the central server in order to preserve a usage record in the central server (S275); the standard AP copy of the designated AP is operated (S280); when the use is finished (Yes at S285), the usage data is recorded in the central server (S290); and the AP standard copy is caused to disappear (S295).

With the order of S200 and S205 in FIG. 7 being reversed, when the user is caused to designate a desired AP, APs whose copies for the user are indicated by the AP use property information to exist at some locations may be displayed on the screen of the user's own portal as a menu that shows the conditions. In that case, if the user chooses an AP from the menu, the user will use the user's own copy that already exists at some location; and as for an AP that is not displayed in the menu, the user will instructs to newly make the user's own copy or to use its standard copy.

In the above-described example, the AP copy operation unit 150 at each location accesses the AP-by-AP usage history DB 250 of the central server each time the use of personal copy/standard copy of an AP is started and finished, in order to surely collect information for charging. However, there are a variety of charging methods, and there may be a configuration in which the need for access to the central server is partly or wholly eliminated when an AP copy is used. In that case, the use declaration on the central server and the recording of usage information are not required; thus S175 and S190 in FIG. 6, S275 and S290 in FIG. 7, and S220 and S230 in FIG. 7 can be omitted.

In particular, in the above-described embodiment, when a personal portal is to be moved, the central server is accessed in order to find which location the portal exists at; but when a personal AP copy is to be moved, which location the copy exists at is allowed to be found from the AP use property information accompanying the personal portal that has been moved to the current location, without access to the central server, and this enhances autonomy of each user accommodation server from the central server. Thus, eliminating the need for the use declaration on the central server and the recording of usage information further enhances autonomy of each user accommodation server from the central server.

In a case where CONFIG information indicating a configuration or the like to be required to operate an application is recorded in the AP-by-AP usage history DB 250, the central server is accessed before the start of operation of a personal AP copy in order to find an environment to be prepared, and the central server is accessed at the end of operation in order to preserve information for the next time. If it is desirable to enhance autonomy of each user accommodation server from the central server, the above-described embodiment can be varied such that this CONFIG information is recorded together in the AP use property information of the user's own portal, instead of being recorded in the central server.

In the embodiment varied that way, a user accommodation server that is to operate a user's own AP copy from now on can obtain CONFIG information by referring to AP use property information accompanying the user's own portal that is held by the user accommodation server itself. At the end of the use of the user's own AP copy, the user accommodation server can rewrite the location in the above AP use property information to the user accommodation server itself, which is the latest move destination, updating the CONFIG information as well. Such a configuration is also included in the scope of the present invention.

On the contrary, in a case of an application in which the central server's participation at each use of an AP copy is considered more important than autonomy from the central server, the AP use property information caused to accompany the user's own portal in the above-described embodiment may be stored in the AP-by-AP usage history DB 250 of the central server. Then, the user's own portal operating in the user accommodation server accesses the central server and refers to the AP use property information, instead of referring to AP use property information accompanying the portal itself.

In the embodiment varied that way, at the start of use of a personal AP copy, a user accommodation server at each location accesses the AP-by-AP usage history DB 250 of the central server to sign in for charging and/or to refer to CONFIG information, as well as to refer to AP use property information to look into which location the personal AP copy exists at. At the end of use, the user accommodation server accesses the central server to record information for charging and/or to update the CONFIG information, as well as to rewrite the location information of the personal AP copy in the above AP use property information to the user accommodation server itself, which is the latest move destination. Such a configuration is also included in the scope of the present invention.

As described above in detail, in the embodiment, the “status” can be preserved and moved such that the program and data of an application can be used in the same “status” regardless of time and place, so to speak. In the system consistent with the embodiment that provides a platform for that purpose, a plurality of operators can provide an identical environment, thereby enabling a personal execution environment to move from/to the exterior, and a service with short delay and high bandwidth can be used anywhere by the user.

In the embodiment, for example, an application can be moved to an access point closest to the user in a place where it is used when it is used, via a personal portal that is the user's entrance environment. In order to enhance autonomy of each location from the central server instead of controlling the above move in a centralized manner, it is desirable to cause the personal portal to have individual information for moving each application and to use the central server as a place to store a pointer thereto.

For this purpose, in the above example, a user accommodation apparatus at each location in the embodiment upon accepting a use request from a user of a connected terminal refers to the staying user storing unit or the each-user staying location storing unit of the central server to determine the user accommodation apparatus with which the user is currently associated, brings over from the user accommodation apparatus the user's own portal including a property for specifying a user accommodation apparatus that holds the user's own copy of each application, brings over from the user accommodation apparatus specified by the property the user's own copy of an application designated by the user, and provides the application service using the user's own copy held by the apparatus concerned.

In the above example, the property for specifying a user accommodation apparatus that holds the user's own copy of each application accompanies the user's own portal. Alternatively, the holding of and reference to the property may be performed separately from the holding of and reference to the portal. Further alternatively, an application can be held and moved with its “status” included even if the system does not provide creation of a user's own portal but does provide the holding and management of the property.

Persons of ordinary skill in the art will realize that many modifications and variations of the above embodiments may be made without departing from the novel and advantageous features of the present invention. For example, there can be a variety of authentic methods for matching an accessing individual with an application/portal, or the like. Accordingly, all such modifications and variations are intended to be included within the scope of the appended claims. The specification and examples are only exemplary. The following claims define the true scope and spirit of the invention.

What is claimed is:

1. A user accommodation apparatus in a system including a plurality of user accommodation apparatuses each having a unit for connecting with a terminal of a user and a central apparatus having a unit for communicating with each of the plurality of user accommodation apparatuses, the user accommodation apparatus concerned comprising:
a unit that accepts a use request from a user of a terminal connected;
a unit that determines which one of the plurality of user accommodation apparatuses the user whose use request is accepted is currently associated with, based on first information managed by the central apparatus;
a unit that uses the determined one of the plurality of user accommodation apparatuses, to obtain second information for specifying where in the system the user's copy of an application program is held;
a unit that causes the user's copy of an application program designated by the user to move from one of the plurality of user accommodation apparatuses specified by the second information to the user accommodation apparatus concerned; and
a unit that causes the user's copy of the designated application program in the user accommodation apparatus concerned to operate to communicate with the terminal, thereby providing a service to the user, the user's copy of the application program being held in the system after the communication with the terminal is finished.

2. The user accommodation apparatus according to claim 1, further comprising:
a unit that holds the user's copy of the designated application program in the user accommodation apparatus concerned, after the communication with the terminal is finished;
a unit that rewrites the second information such that the second information specifies that the user's copy of the designated application program is held in the user accommodation apparatus concerned; and
a unit that moves, upon a request from another user accommodation apparatus, the user's copy of the designated application program from the user accommodation apparatus concerned to said another user accommodation apparatus.

3. The user accommodation apparatus according to claim 2, further comprising
a unit that moves the user's copy of the designated application program held in the user accommodation apparatus concerned to the central apparatus when there are no requests from other user accommodation apparatuses for a prescribed time period or when there occurs any trouble in holding in the user accommodation apparatus concerned.

4. The user accommodation apparatus according to claim 1, further comprising
a unit that stores information indicating which user is currently associated with the user accommodation apparatus concerned, wherein
when the stored information indicates that the user whose use request is accepted is currently associated with the user accommodation apparatus concerned, the determination based on the first information is performed by determining the user accommodation apparatus concerned to be the one with which the user is currently associated, and when the stored information indicates that the user is not associated, the determination based on the first information is performed by communicating with the central apparatus to cause the first information to be referred to, thereby searching for the user accommodation apparatus with which the user is currently associated.

5. The user accommodation apparatus according to claim 1, further comprising:
a unit that enables the user's copy of the designated application program to be newly created when the second information indicates that the user's copy of the designated application program does not exist in the system; and
a unit that makes an addition to the second information such that the second information specifies that, as to the application program whose copy for the user is newly created, the user's copy is held in the user accommodation apparatus concerned.

6. The user accommodation apparatus according to claim 1, wherein
the user accommodation apparatus with which the user is currently associated holds a portal program for the user and the second information, and
the obtainment of the second information includes:
causing the portal program for the user and the second information to move from the determined one of the plurality of user accommodation apparatuses to the user accommodation apparatus concerned;
causing the portal program for the user in the user accommodation apparatus concerned to operate;
causing the user to designate a desired application program through communication between the portal program and the terminal; and
causing the second information in the user accommodation apparatus concerned to be referred to for the designated application program.

7. The user accommodation apparatus according to claim 1, wherein
the user accommodation apparatus with which the user is currently associated holds a portal program for the user,
the central apparatus manages the second information, and
the obtainment of the second information includes:
causing the portal program for the user to move from the determined one of the plurality of user accommodation apparatuses to the user accommodation apparatus concerned;
causing the portal program for the user in the user accommodation apparatus concerned to operate;
causing the user to designate a desired application program through communication between the portal program and the terminal; and
causing the second information to be referred to for the designated application program through communication between the portal program and the central apparatus.

8. The user accommodation apparatus according to claim 1, further comprising:
a unit that causes a portal program for the user to move to the user accommodation apparatus concerned;
a unit that causes the portal program for the user in the user accommodation apparatus concerned to operate to communicate with the terminal;
a unit that holds the portal program for the user in the user accommodation apparatus concerned, after the communication with the terminal is finished;
a unit that causes the central apparatus to rewrite the first information such that the user accommodation apparatus concerned is determined to be the one with which the user is currently associated; and
a unit that moves, upon a request from another user accommodation apparatus, the portal program for the user from the user accommodation apparatus concerned to said another user accommodation apparatus.

9. The user accommodation apparatus according to claim 1, further comprising:
a unit that enables a portal program for the user whose use request is accepted to be newly created when the first information indicates that the portal program for the user does not exist in the system; and
a unit that causes, in response to the new creation of the portal program for the user, the central apparatus to generate the first information such that the user accommodation apparatus concerned is determined to be the one with which the user is currently associated.

10. The user accommodation apparatus according to claim 1, wherein
the second information is accompanied by third information indicating resources to be reserved for operation of the user's copy of an application program, and
the user accommodation apparatus concerned reserves the resources determined based on the third information, in advance of the movement of the user's copy of the application program.

11. The user accommodation apparatus according to claim 1, wherein
the user accommodation apparatus with which the user is currently associated holds the second information,
the obtainment of the second information includes causing the second information to move from the determined one of the plurality of user accommodation apparatuses to the user accommodation apparatus concerned,
the central apparatus manages third information indicating resources to be reserved for operation of the user's copy of an application program, and
the user accommodation apparatus concerned reserves the resources determined by obtaining the third information through communication with the central apparatus, in advance of the movement of the user's copy of the application program.

12. The user accommodation apparatus according to claim 1, further comprising:
a unit that newly creates a general-purpose copy of an application program designated by the user;
a unit that causes the general-purpose copy of the application program to operate to communicate with the terminal; and
a unit that causes the general-purpose copy of the application program to disappear, after the communication with the terminal is finished.

13. A system for providing services, comprising:
a plurality of user accommodation apparatuses each having a unit for connecting with a terminal of a user to provide a service to the user, the user's copy of an application program being held in the system; and
a central apparatus having a unit for communicating with each of the plurality of user accommodation apparatuses, wherein
the central apparatus manages first information indicating which one of the plurality of user accommodation apparatuses the user is currently associated with,
one of the plurality of user accommodation apparatuses, which the user is currently associated with, holds second information for specifying where in the system the user's copy of each application program is held, and
each of the plurality of user accommodation apparatuses comprises:
a unit that accepts a use request from a user of a terminal connected;
a unit that determines which one of the plurality of user accommodation apparatuses the user whose use request is accepted is currently associated with, based on the first information;
a unit that acquires the second information from the determined one of the plurality of user accommodation apparatuses;
a unit that causes the user's copy of an application program designated by the user to move from one of the plurality of user accommodation apparatuses specified by the second information to the user accommodation apparatus concerned; and
a unit that causes the user's copy of the designated application program in the user accommodation apparatus concerned to operate to communicate with the terminal.

14. The system according to claim 13, wherein
the user accommodation apparatus holding the second information changes and the first information is rewritten such that there is only one user accommodation apparatus with which the user is currently associated among the plurality of user accommodation apparatuses, and
the user's copy of the application program moves and the second information is rewritten such that there is only one user accommodation apparatus holding the copy among the plurality of user accommodation apparatuses.

15. A system for providing services, comprising:
a plurality of user accommodation apparatuses each having a unit for connecting with a terminal of a user to provide a service to the user, the user's copy of an application program being held in the system; and
a central apparatus having a unit for communicating with each of the plurality of user accommodation apparatuses, wherein
the central apparatus manages first information indicating which one of the plurality of user accommodation apparatuses the user is currently associated with,
one of the plurality of user accommodation apparatuses, which the user is currently associated with, holds a portal program for the user, and
each of the plurality of user accommodation apparatuses comprises:
a unit that accepts a use request from a user of a terminal connected;
a unit that determines which one of the plurality of user accommodation apparatuses the user whose use request is accepted is currently associated with, based on the first information;
a unit that causes the portal program for the user to move from the determined one of the plurality of user accommodation apparatuses to the user accommodation apparatus concerned;
a unit that causes the portal program for the user in the user accommodation apparatus concerned to operate, causing second information for specifying where in the system the user's copy of an application program designated by the user is held to be referred to, and causing the user's copy of the designated application program to move from one of the plurality of user accommodation apparatuses specified by the second information to the user accommodation apparatus concerned; and
a unit that causes the user's copy of the designated application program in the user accommodation apparatus concerned to operate to communicate with the terminal.

16. The system according to claim 15, wherein
the user accommodation apparatus holding the portal program changes and the first information is rewritten such that there is only one user accommodation apparatus with which the user is currently associated among the plurality of user accommodation apparatuses, and
the user's copy of the application program moves and the second information is rewritten such that there is only one user accommodation apparatus holding the copy among the plurality of user accommodation apparatuses.

17. The service provision system according to claim 15, wherein
the user's copy of each application program is held in one of the plurality of user accommodation apparatuses with data and status information of the application program included, and
information for charging for a service provided by an application program designated by the user is collected from the user accommodation apparatus holding the user's copy of the application program to the central apparatus.

18. The system according to claim 15, wherein
the user accommodation apparatus holding the user's copy of the application program has a unit for causing the copy to keep operating while not connected with the terminal of the user, and
the movement of the user's copy of the application program is performed, causing the copy to keep operating while moving the copy.

19. The system according to claim 15, wherein
virtual middleware is installed in each of the plurality of user accommodation apparatuses, such that the user's identical copy of each application program can operate in any one of the plurality of user accommodation apparatuses.

20. The system according to claim 15, wherein
each of the plurality of user accommodation apparatuses further comprises a unit for connecting with another of the plurality of user accommodation apparatuses not via the central apparatus.

21. A method of providing a service to a user in a system that including a plurality of user accommodation apparatuses each having a unit for connecting with a terminal of the user and a central apparatus having a unit for communicating with each of the plurality of user accommodation apparatuses, the method comprising:
configuring the system to hold the user's copy of an application program;
locating in the central apparatus first information indicating which one of the plurality of user accommodation apparatuses the user is currently associated with;
causing a user accommodation apparatus among the plurality of user accommodation apparatuses that has accepted a use request from a user of a terminal to determine which one of the plurality of user accommodation apparatuses the user is currently associated with based on the first information, and to use the determined one of the plurality of user accommodation apparatuses to obtain second information for specifying where in the system the user's copy of an application program is held;
moving the user's copy of an application program designated by the user from one of the plurality of user accommodation apparatuses specified by the second information to the user accommodation apparatus that has accepted the use request; and
causing the user accommodation apparatus that has accepted the use request to operate the moved user's copy of the application program to communicate with the terminal.

22. A computer usable medium having computer readable program codes embodied therein to be incorporated into a computer system, whereby the computer system functions as a system that comprises a plurality of user accommodation apparatuses each having a unit for connecting with a terminal of a user to provide a service to the user and a central apparatus having a unit for communicating with each of the plurality of user accommodation apparatuses, the computer readable program codes comprising:
program codes for configuring the system to hold the user's copy of an application program;
program codes for locating in the central apparatus first information indicating which one of the plurality of user accommodation apparatuses the user is currently associated with;
program codes for causing a user accommodation apparatus among the plurality of user accommodation apparatuses that has accepted a use request from a user of a terminal to determine which one of the user accommodation apparatuses the user is currently associated with based on the first information, and to use the determined one of the plurality of user accommodation apparatuses to obtain second information for specifying where in the system the user's copy of an application program is held;
program codes for moving the user's copy of an application program designated by the user from one of the plurality of user accommodation apparatuses specified by the second information to the user accommodation apparatus that has accepted the use request; and
program codes for causing the user accommodation apparatus that has accepted the use request to operate the moved user's copy of the application program to communicate with the terminal.
